(19) United States
(12) Patent Application Publication
(10) Pub. No.: US 2026/0341041 A1
(43) Pub. Date: Oct. 29, 2026

(54) OBJECT DETECTION USING TEMPORAL INFORMATION FOR AUTONOMOUS AND SEMI-AUTONOMOUS SYSTEMS AND APPLICATIONS

(71) Applicant: NVIDIA Corporation, Santa Clara, CA (US)

(72) Inventors: Seungwoo Yoo, Yongin (KR); Xin Meng, Beijing (CN); Rui Shen, San Jose, CA (US)

(21) Appl. No.: 19/200,062

(22) Filed: May 6, 2025

(30) Foreign Application Priority Data
Apr. 29, 2025 (CN) 202510565218X

(51) Int. Cl. G06V 20/58; G06V 10/44; G06V 10/82

(52) U.S. Cl. CPC G06V 20/584; G06V 10/454; G06V 10/82

(57) ABSTRACT

In various examples, using temporal information to detect object attributes for autonomous and/or semi-autonomous systems and applications is described herein. Systems and methods are disclosed that use one or more neural networks—such as a convolution neural network (CNN)—to determine attributes associated with objects based on temporal information. For instance, the neural network(s) may use one or more first layers—such as a CNN feature extractor—to determine spatial features associated with images representing an object, where the spatial features are then stored in a memory. The neural network(s) may then use one or more second layers-such as one or more CNN classifiers-to process the spatial features and determine a classification and/or one or more attributes associated with the object.

### BACKGROUND

Determining various object attributes using image data—such as temporal attributes that change over periods of time—is important for many autonomous and/or semi-autonomous operations of machines. For example, determining whether a vehicle is turning, reversing, and/or braking based on states of light signals of the vehicle is important for an autonomous machine that is navigating in proximity to the vehicle. However, determining such object attributes may be difficult in some circumstances, such as when visual characteristics are ambiguous in a single image (e.g., the light signals are switching between states) and/or at least a portion of the object is occluded (e.g., the light signals are occluded within the image). Additionally, since similar types of objects may include varying configurations—such as different models of vehicles including light signals that differ in shapes and/or locations—determining attributes for all of the various configurations may add to the challenge.

As such, multiple techniques have been developed to determine object attributes using image data. For instance, computer-vision techniques may process image data to identify light locations and then apply heuristics to determine light states. However, these techniques tend to only work in constrained environments, which provides poor performance when there is diverse weather and/or lighting conditions due to the hand-tuned heuristics. As such, deep learning-based techniques leverage deep learning algorithms—such as those based on a recurrent neural network (RNN)—to identify light locations, extract spatial features, and then integrate temporal information through the RNN. However, in some circumstances, it may be difficult to analyze temporal information using the hidden states of an RNN. Additionally, problems may occur based on the difference in processing times of the RNN between training and deployment. For example, the RNN may be trained using a fixed time sequence and, when deployed, the RNN may continuously track light signals until the light signals are no longer depicted by images.

### SUMMARY

Embodiments of the present disclosure relate to using temporal information to detect object attributes for autonomous and/or semi-autonomous systems and applications. Systems and methods are disclosed that use one or more neural networks—such as one or more convolution neural networks (CNN(s))—to determine attributes associated with objects based on temporal information. For instance, the neural network(s) may use one or more first layers—such as a CNN feature extractor—to determine spatial features associated with images representing an object, where the spatial features are then stored in a memory. The neural network(s) may then use one or more second layers—such as one or more CNN classifiers—to process the spatial features and determine a classification of the object and/or one or more attributes associated with the object. For instance, if the object includes a vehicle with light signals, then the neural network(s) may determine one or more states of the light signals. As described in more detail herein, in some examples, the neural network(s) may determine the attribute(s) based on the occurrence of one or more events, such as the memory storing a threshold amount of the spatial features.

In contrast to conventional systems, the systems and methods of the present disclosure, in some embodiments, use the temporal CNN with optimized convolution layers to determine object attributes rather than using an RNN. This may improve the performance of determining the object attributes—such as by avoiding recurrent hidden states—while also improving the training process. For instance, training the temporal CNN may bypass various RNN training issues like gradient vanishing. Additionally, in contrast to conventional systems, the systems and methods of the present disclosure, in some embodiments, aggregate the temporal information (e.g., the spatial features) simultaneously instead of sequentially for performing the analysis to determine the object attributes. This may further improve the performance of a neural network by analyzing the contribution from multiple timesteps (e.g., each timestep) each time the object attributes are determined. Furthermore, the systems and methods of the present disclosure, in some embodiments, may use a pure CNN architecture which simplifies deployment as compared to the RNN architecture of the conventional systems.

### BRIEF DESCRIPTION OF THE DRAWINGS

The present systems and methods for using temporal information to detect object attributes for autonomous and/or semi-autonomous systems and applications are described in detail below with reference to the attached drawing figures, wherein:

FIG. 1 illustrates an example data flow diagram for a process of using temporal information to determine attributes associated with objects, in accordance with some embodiments of the present disclosure;

FIG. 2 illustrates an example of generating and storing feature information associated with images in a memory, in accordance with some embodiments of the present disclosure;

FIGS. 3A-3B illustrate examples of storing additional information in a memory as placeholders for spatial information associated with images, in accordance with some embodiments of the present disclosure;

FIGS. 4A-4B illustrate examples of architectures associated with neural networks that may perform one or more of the processes described herein, in accordance with some embodiments of the present disclosure;

FIG. 5 illustrates an example of a process for training one or more neural networks to perform at least a portion of the processing described herein, in accordance with some embodiments of the present disclosure;

FIG. 6 illustrates a flow diagram showing a method for using temporal information to determine attributes associated with objects, in accordance with some embodiments of the present disclosure;

FIG. 7 illustrates a flow diagram showing a method for using stored feature information to determine attributes associated with objects, in accordance with some embodiments of the present disclosure;

FIG. 8A is an example of sensor locations having corresponding fields of view or sensory fields for example autonomous or semi-autonomous machines, in accordance with at least some embodiments of the present disclosure;

FIG. 8B is an illustration of an example of component and sensor locations on an autonomous or semi-autonomous vehicle, in accordance with at least some embodiments of the present disclosure;

FIG. 8C is a block diagram of an example system architecture for an autonomous or semi-autonomous vehicle, robot, and/or other machine type, in accordance with at least some embodiments of the present disclosure;

FIG. 8D is a block diagram of an example architecture of a computing system—such as a system-on-a-chip (SoC)—in accordance with at least some embodiments of the present disclosure;

FIG. 8E is a system diagram for communication between cloud-based server(s) and an example autonomous or semi-autonomous vehicle, robot, and/or other machine type, in accordance with at least some embodiments of the present disclosure;

FIG. 9 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 10 is a block diagram of an example computing system for generative artificial intelligence (AI), in accordance with at least some embodiments of the present disclosure; and

FIG. 11 is a block diagram of an example computing device, in accordance with at least some embodiments of the present disclosure.

### DETAILED DESCRIPTION

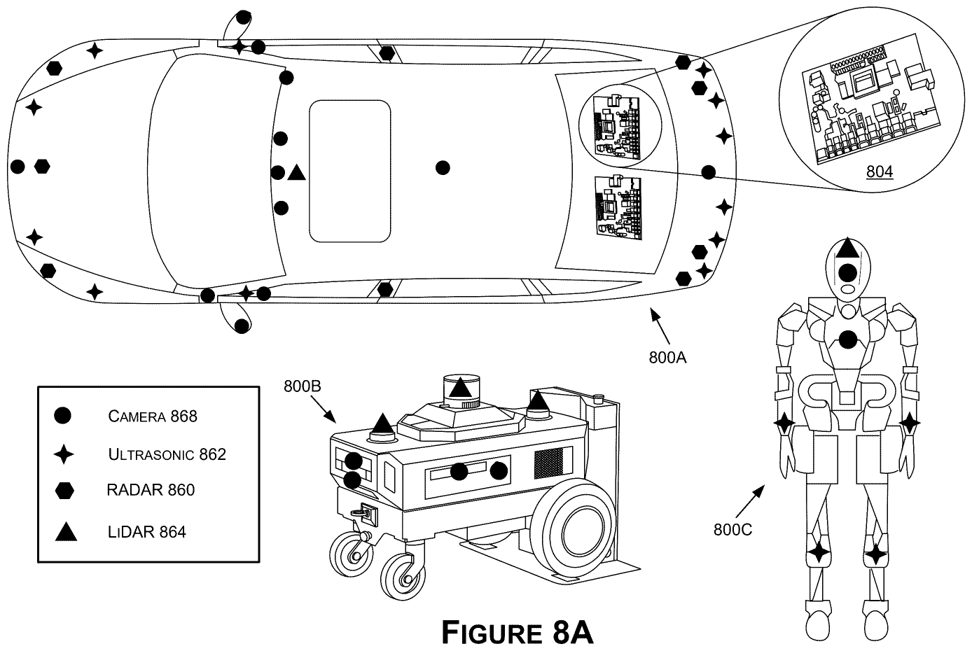

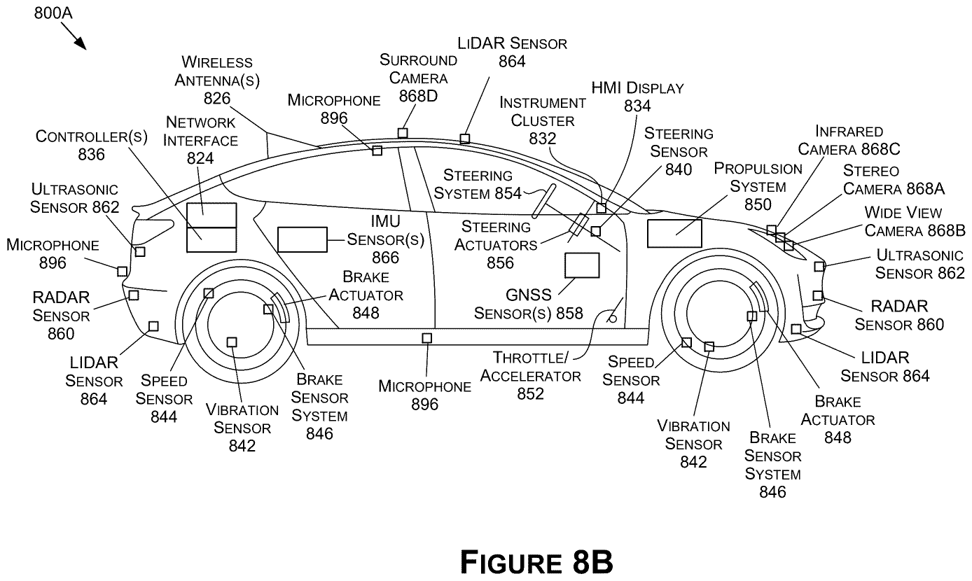

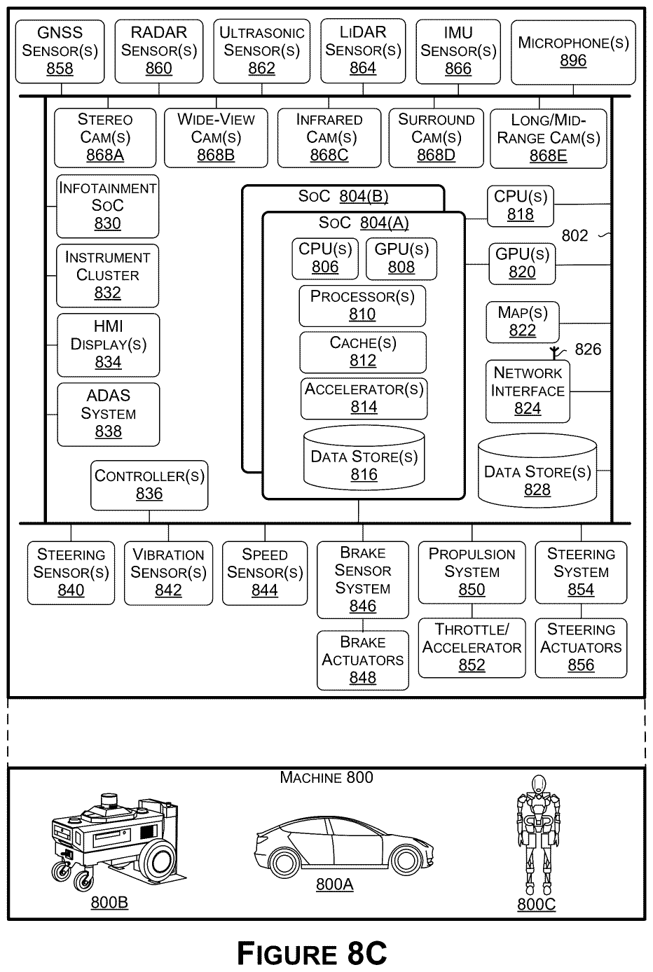

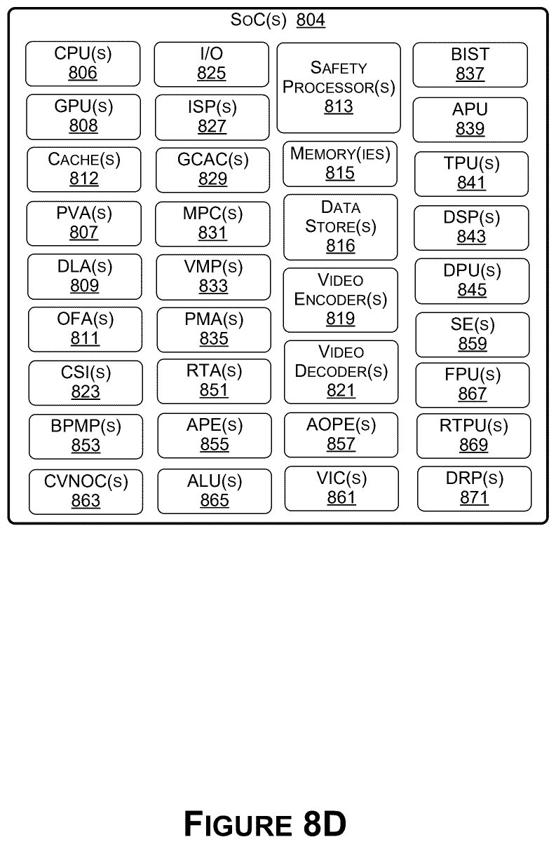

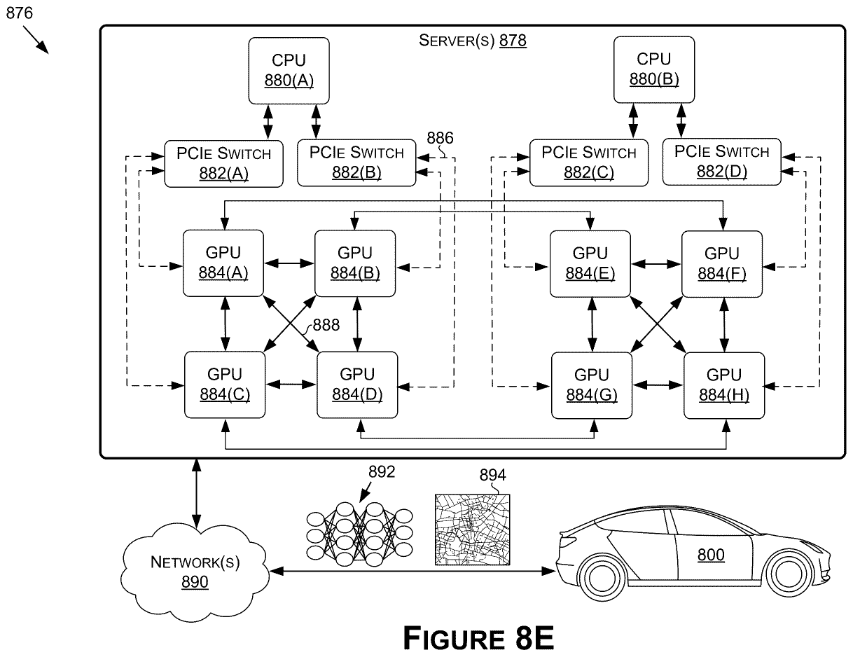

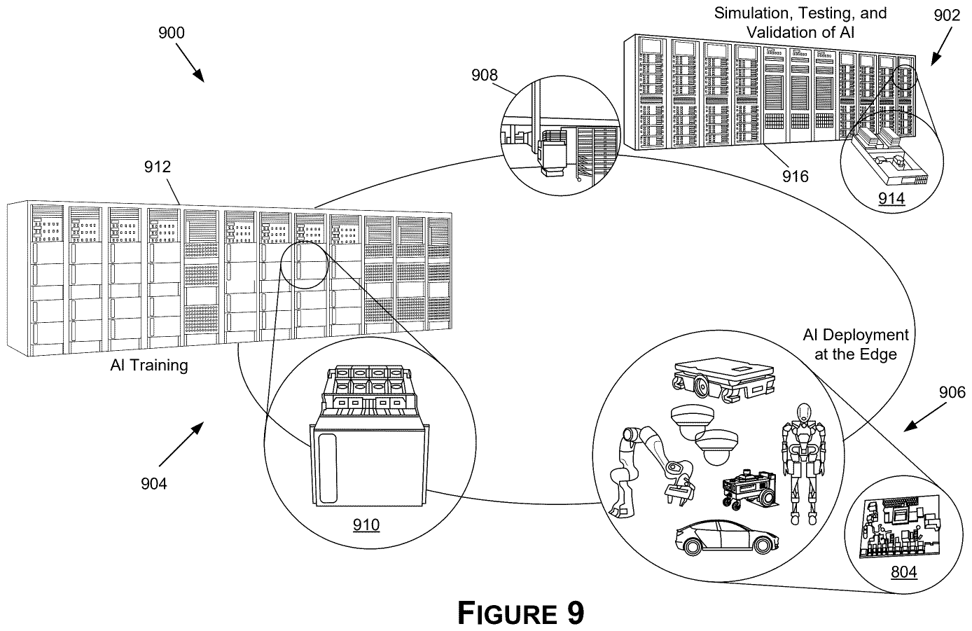

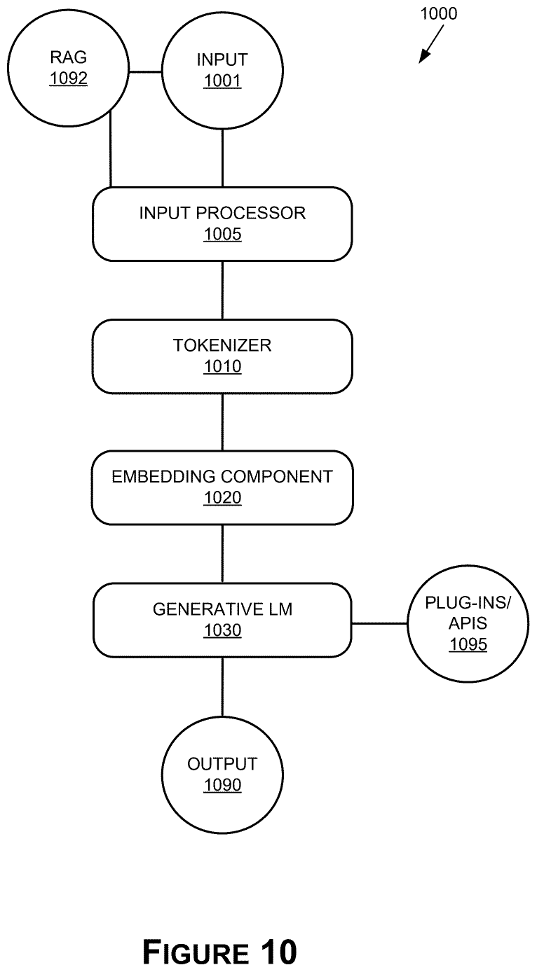

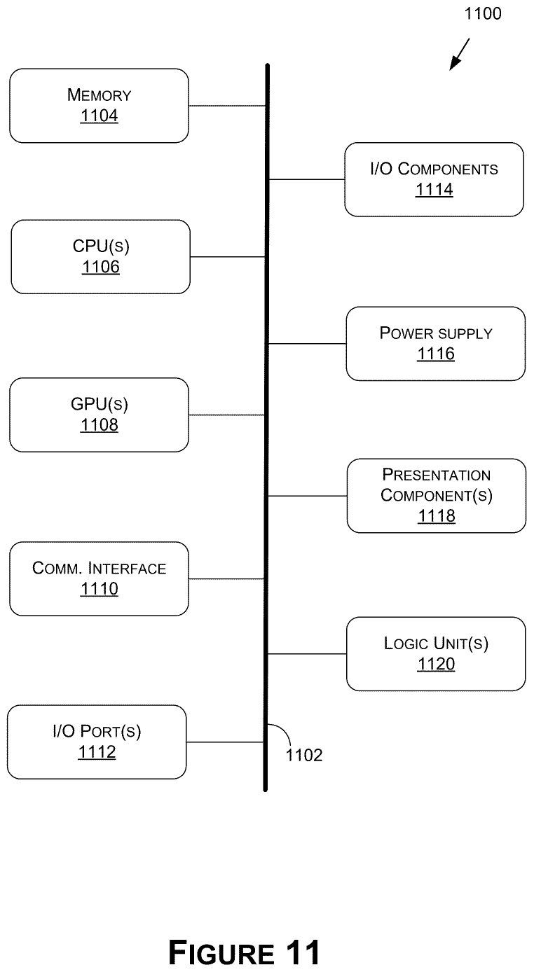

Systems and methods are disclosed related to using temporal information to detect object attributes for autonomous and/or semi-autonomous systems and applications. Although the present disclosure may be described with respect to an example autonomous or semi-autonomous vehicle, robot, and/or other machine type 800 (alternatively referred to herein as “vehicle 800,” “ego-vehicle 800,” “machine 800,” “ego-machine 800,” “robot 800,” and/or “ego-robot 800,” an example of which is described with respect to FIGS. 8A-8E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and unpiloted robots or robotic platforms (e.g., autonomous mobile robots (AMRs), humanoid robots, robotic arms and/or end-effectors), warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to object detection and/or classifications, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where attribute detection and/or classification may be used. In some embodiments, the systems, methods, and/or processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

For instance, a system(s) may receive, generate, obtain, and/or retrieve image data obtained using one or more image sensors of a machine. As described herein, the image data may represent one or more images depicting at least an object located within the environment. For example, the image data may represent images of another machine (and/or other type of traffic feature) within the environment—such as a vehicle—that includes one or more light signals. In some examples, the system(s) may then process at least a portion of the image data using one or more image processing tasks. For instance, the system(s) may process the image data to generate processes image data representing one or more cropped images that depict a greater portion of the object as compared to the surrounding environment. In some examples, the system(s) may use any technique to perform the processing task(s), such as using a machine learning model, a neural network, a classifier, an algorithm, a processor, and/or any other type of processing component.

The system(s) may then process the processed image data (and/or the image data) using one or more neural networks that are trained to determine information associated with the object, such as a classification associated with the object, one or more attributes associated with the object, and/or any other information. For a first example, if the object is another machine within the environment that includes at least one or more light signals, then the neural network(s) may be trained to determine at least a classification of the machine—such as vehicle and/or a type of vehicle—along with one or more states of the machine and/or the light signal(s). As described herein, a state for the light signal may include, but is not limited to, cycling (e.g., repeating turning on and off), on, off, and/or any other state. Additionally, a state for the machine may related to the state of one or more light signals such as by including, but not being limited to, being in an emergency situation (e.g., if the machine is an emergency vehicle), turning left, turning right, reversing, stopping, and/or any other state. For a second example, if the object is a dynamic object, then the neural network(s) may be trained to determine a classification of the object—such as machine (e.g., car, van, bus, truck, motorcycle, etc.), person, animal, and/or the like—along with motion information associated with the object (e.g., a velocity, an acceleration, a direction of travel, etc.).

To process the image data, the neural network may include one or more feature extractors—such as a CNN extractor (and/or any other type of extractor, such as but not limited to those described herein)—that processes the image data to generate feature information associated with the image(s). For example, and for an image, the feature information may include one or more spatial features and/or a feature vector associated with the image. The system(s) may then store the feature information in a memory, such as in an order in which the feature information is generated. For example, the system(s) may store first feature information associated with a first image in the memory, followed by second feature information associated with a subsequent second image, followed by third feature information associated with a subsequent third image, and/or so forth. Additionally, in some examples, the system(s) may perform these processes until the memory is full. For example, if the memory includes storage for feature information associated with fifteen images, then the system(s) may store fifteen instances of the feature information in the memory. Furthermore, in some examples, such as when the memory is full, the system(s) may remove older feature information from the memory while continuing to store new feature information in the memory. For example, the memory may include a (rolling) buffer memory that continuously stores the newest feature information associated with newest images.

In some examples, the system(s) may perform additional storing processes associated with the memory, such as before the memory is full of the feature information. For a first example, the system(s) may initially store placeholder information that does not represent features associated with images. For instance, the placeholder information may include one or more predefined value vectors, such as one or more zero vectors (and/or any other value vectors). For a second example, the system(s) may generate copies of one or more instances of the feature information and then store the feature information copies in the memory. In either of these examples, the system(s) may perform such processes to keep the memory full. Additionally, the system(s) may initially remove this added information (e.g., the placeholder information and/or the feature information copies) when storing the new feature information in the memory.

The neural network(s) may then further process the feature information (and/or the placeholder information)—such as by using one or more classifiers—to determine the classification and/or the attribute(s) associated with the object. In some examples, the system(s) may process the feature information based on the occurrence of one or more events, such as a capacity of the memory satisfying a threshold (e.g., the memory becoming full). Additionally, the neural network(s) may include various architectures for processing the feature information. For a first example, the neural network(s) may include one or more temporal classifiers—such as a temporal CNN classifier (and/or any other type of temporal classifier, which is described herein)—that are configured to process the feature information and determine the classification and/or the attribute(s) associated with the object. For a second example, the neural network(s) may include the temporal classifier(s) that are configured to process the feature information to determine the attribute(s) and one or more other classifiers—such as another CNN classifier (and/or any other type of classifier, which is described herein)—that are configured to process at least a portion of the feature information (e.g., an instance of the feature information that is associated with a frame) to determine the classification associated with the object. While these are two example architectures for the neural network(s) to process the feature information, in other examples, the neural network(s) may include additional and/or alternative architectures.

In some examples, the system(s) may then continue to perform these processes of processing additional image data to continue determining the classification and/or the attribute(s) associated with the object. For instance, the neural network(s) may process every image represented by the image data, every other image represented by the image data, every fourth image represented by the image data, and/or any other interval of the image data to determine a classification and/or one or more attributes associated with the object. This is because, in some examples, the attribute(s) may change over a period of time, such as when the object performs a new maneuver. Additionally, in some examples, the system(s) may perform these processes to determine one or more classifications and/or one or more attributes associated with one or more additional objects.

In some examples, the neural network(s) may be trained to perform one or more of the processes described herein. For instance, the neural network(s) may be trained using at least training input data representing videos depicting objects over periods of time along with ground truth data representing classifications and/or attributes associated with the objects. For example, the neural network(s) may process the training input data and generate output data representing predicted classifications and/or predicted attributes associated with the objects. The system(s) may then compare the predicted classifications and/or the predicted attributes to the ground truth classifications and/or the ground truth attributes to determine one or more losses. Additionally, the system(s) may use the loss(es) to update the weights and/or parameters of the neural network(s). For example, the system(s) may use the loss(es) to update at least the weights and/or parameters of the feature extractor(s) and/or the classifier(s). As described in more detail herein, the system(s) may further perform one or more additional processes to improve the training, such as using temporal random jittering and/or dropping instances of spatial features randomly.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine classifications and/or attributes associated with objects etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., image data representing objects from within the simulation. The synthetic training data (in addition to or alternatively from real-world data) may then be used or processed using the neural network(s) to determine the classifications and/or attributes of objects.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to determine classifications and/or attributes of objects that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), Vision Transformers, and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and unpiloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

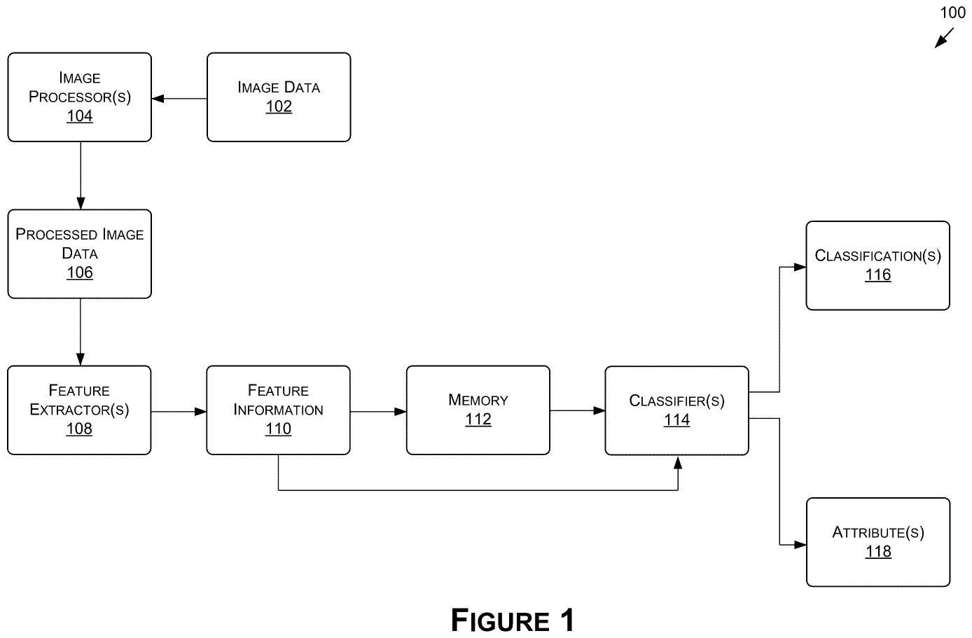

With reference to FIG. 1, FIG. 1 illustrates an example data flow diagram for a process 100 of using temporal information to determine attributes associated with objects, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

The process 100 may include receiving, generating, obtaining, and/or retrieving image data 102 obtained using one or more image sensors of a machine (e.g., an example machine 800). As described herein, the image data 102 may represent one or more images depicting at least an object located within the environment. For a first example, the image data 102 may represent images depicting another machine within the environment—such as a vehicle—that includes one or more light signals. For a second example, the image data 102 may represent images depicting a dynamic object—such as a pedestrian—moving throughout the environment. In some examples, and as illustrated in FIG. 1, the process 100 may then include using one or more image processors 104 to process at least a portion of the image data 102 to generate processed image data 106. For example, the image processor(s) 104 may process the image data 102 to generate processed image data 106 representing one or more cropped images that depict a greater portion of the object as compared to the surrounding environment. In such an example, an image processor 104 may include a machine learning model, a neural network, a classifier, an algorithm, a processor, and/or any other type of processing component.

The process 100 may then include using one or more feature extractors 108 to process the processed image data 106 (and/or, in some examples, the image data 102) to generate one or more instances of feature information 110 associated with the image(s). As described herein, in some examples, any method for performing feature extraction may be used, such as a learning-based method (e.g., CNN, pre-trained models, etc.), a pixel-based method, a transform-based method (e.g., Fourier Transform, etc.), a filter-based method (e.g., edge detection, corner detection, etc.), and/or a descriptor-based method (e.g., Scale-Invariant Feature Transform, Speeded-Up Robust Features, etc.). For example, the feature extractor(s) 108 may include one or more CNN extractors that are configured to process the processed image data 106 to generate the feature information 110. Additionally, for an image, the feature information 110 may include one or more spatial features, one or more feature vectors, and/or any other representation of feature information.

The process 100 may then include storing the feature information 110 in a memory 112. As described herein, in some examples, the instances of the feature information 110 may be stored in the memory 112 using an order as the feature extractor(s) 108 is generating the feature information. For example, first feature information 110 associated with a first image may be in the memory 112, followed by second feature information 110 associated with a subsequent second image, followed by third feature information 110 associated with a subsequent third image, and/or so forth. Additionally, in some examples, the feature information 110 may continue to be stored in the memory 112 until the memory 112 is full. For example, if the memory 112 includes storage for feature information 110 associated with ten images, then ten instances of the feature information 110 may be stored in the memory 112. Furthermore, in some examples, such as when the memory 112 is full, older feature information 110 may be removed from the memory 112 while new feature information 110 is continued to be stored in the memory 112. For example, the memory 112 may include a buffer memory that continuously stores the newest feature information 110 associated with newest images.

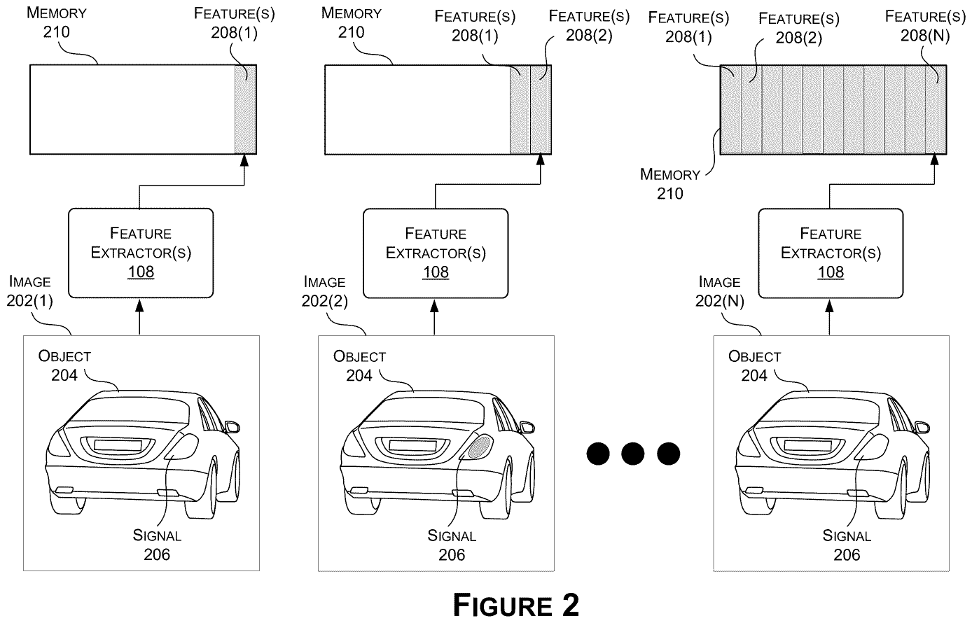

For more details, FIG. 2 illustrates an example of generating and storing feature information associated with images in a memory, in accordance with some embodiments of the present disclosure. As shown, the feature extractor(s) 108 may process image data representing images 202(1)-(N) (also referred to singularly as “image 202” or in plural as “images 202”). In the example of FIG. 2, the images 202 may represent an object 204—such as a vehicle—that includes at least a light signal 206. Based at least on processing the first image 202(1), the feature extractor(s) 108 may generate one or more first spatial features 208(1) associated with the first image 202(1) which are then stored in a memory 210 (which may include, and/or be similar to, the memory 112). Next, based at least on processing the second image 202(2), the feature extractor(s) 108 may generate one or more second spatial features 208(2) associated with the second image 202(2) which are then stored in the memory 210. This process may then continue until processing the final image 202(N) where, based at least on the processing, the feature extractor(s) 108 may generate one or more final spatial features 208(N) associated with the final image 202(N) which are then stored in the memory 210.

As such, in the example of FIG. 2, the memory 210 may be configured to store a specific amount of spatial features 208(1)-(N) (also referred to singularly as “spatial feature(s) 208” or in plural as “spatial features 208”) associated with the images 202. For example, the memory 210 may be configured to store eleven instances of the spatial feature(s) 208 which are associated with eleven images 202. In some examples, the specific amount of spatial features 208 may be based on one or more factors, such as a framerate associated with the images 202, a time period, a cycle associated with an attribute being analyzed, and/or any other factor. For a first example, if the memory 210 is to store a specific time period of the images 202, then the framerate associated with the images 202 may be used to determine the number of images for which spatial features should be stored. For a second example, if light signals include a specific time period to perform a complete cycle (e.g., from an off state, to an on state, and to another off state), then spatial features associated with enough images 202 to cover at least the specific time period may be stored in the memory 210.

Additionally, in some examples, the feature extractor(s) 108 may continue to process additional images in order to generate additional spatial features for storage in the memory 210. In such examples, when storing the additional spatial features in the memory 210, the older spatial features may initially be removed from the memory 210. For example, if the feature extractor(s) 108 processes a new image to generate one or more new spatial features, then the first spatial features 208(1) may be deleted from the memory 210 while the new spatial feature(s) is stored in the memory 112.

Referring back to the example of FIG. 1, in some examples, the process 100 may include performing additional storing processes associated with the memory 112, such as before the memory 112 is full of the feature information 110. For a first example, the process 100 may include initially storing placeholder information that does not represent features associated with images. For example, the placeholder information may include one or more predefined value vectors, such as one or more zero vectors (and/or any other value vector). In such an example, the value(s) of the vector(s) may be prespecified and/or learned, such as during training. For a second example, the process 100 may include generating copies of one or more instances of the feature information 110 and then storing the copies of the feature information 110 in the memory 112. In either of these examples, the process 100 may perform such processes to keep the memory 112 full. Additionally, the process 100 may initially remove this added information (e.g., the placeholder information and/or the copies of the feature information 110) when storing the new feature information 110 in the memory 112.

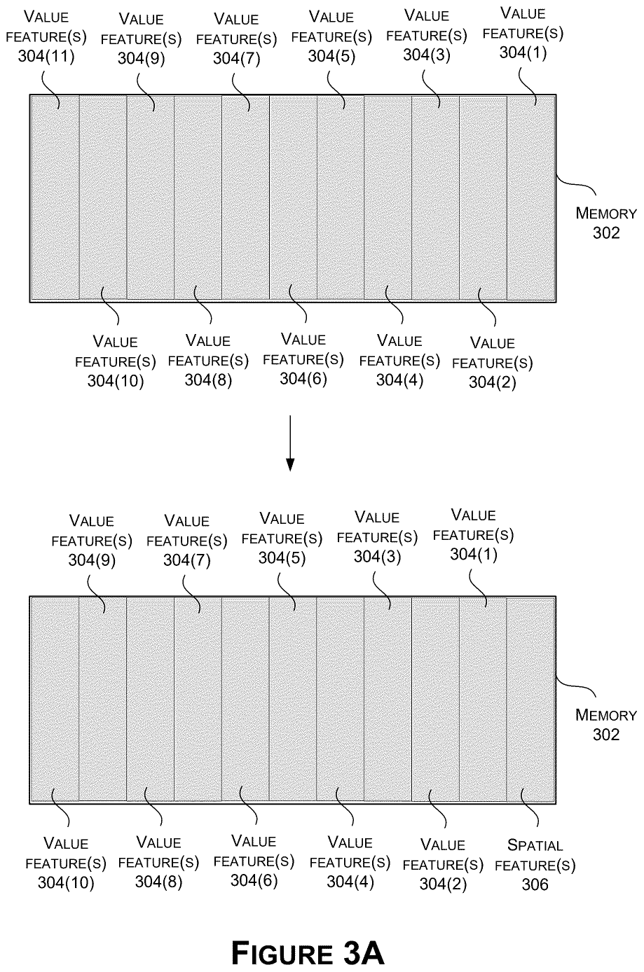

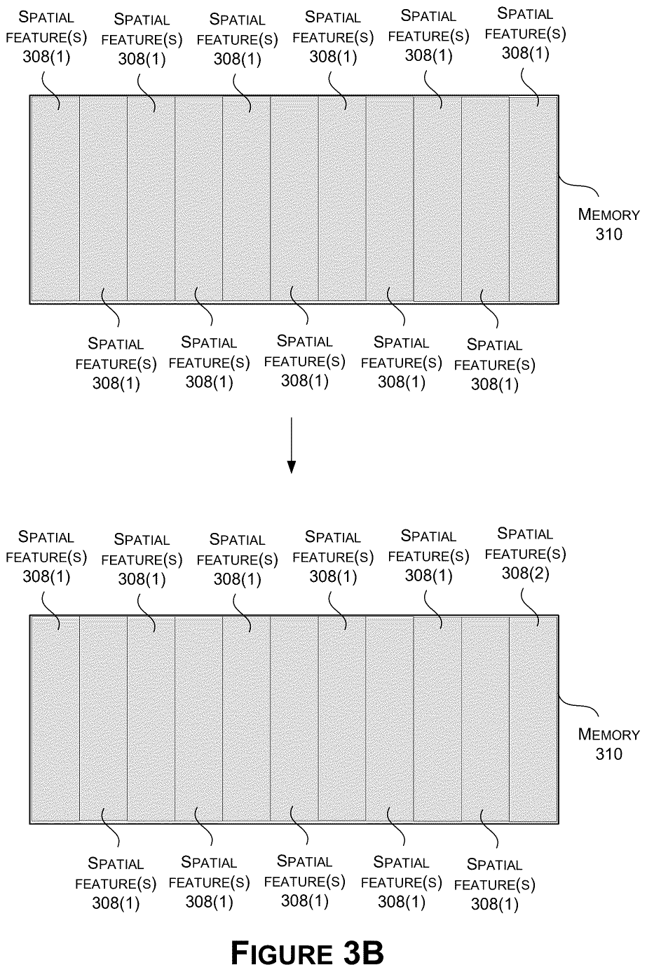

For more details, FIGS. 3A-3B illustrate examples of storing additional information in a memory as placeholders for spatial information associated with images, in accordance with some embodiments of the present disclosure. As shown by the example of FIG. 3A and by the top illustration, a memory 302 (which may include, and/or be similar to, the memory 112) may initially store value features 304(1)-(11) (also referred to as “value features 304”). For instance, in some examples, the value features 304 may include zero vectors (and/or any other value vectors) stored in the memory 302. Next, and as shown by the bottom illustration, the feature extractor(s) 108 may process an image and generate one or more spatial features 306 associated with the image. As such, the last value feature(s) 304(11) may be removed from the memory 302 and the spatial feature(s) 306 may be stored in the memory 302. In some examples, this process may then continue as the feature extractor(s) 108 continues to generate additional spatial features associated with additional images for storage in the memory 302.

Next, as shown by the example of FIG. 3B and by the top illustration, the feature extractor(s) 108 may process a first image and generate one or more first spatial features 308(1) associated with the first image. Additionally, the first spatial feature(s) 308(1) may then be copied to generate additional instance of the first spatial feature(s) 308(1) for storage in a memory 310 (which may include, and/or be similar to, the memory 302). Next, and as shown by the bottom illustration, the feature extractor(s) 108 may process a second image and generate one or more second spatial features 308(2) associated with the second image. As such, an instance of the first spatial feature(s) 308(1) may be removed from the memory 310 while the second spatial feature(s) 308(2) is stored in the memory 310. In some examples, this process may then continue to repeat as the feature extractor(s) 108 continues to generate additional spatial features associated with additional images for storage in the memory 310.

While the example of FIG. 3B illustrates removing only a single instance of the first spatial feature(s) 308(1) from the memory 310 to store only a single instance of the second spatial feature(s) 308(2), in other examples, the second spatial feature(s) 308(2) may be copied to generate additional instances of the second spatial feature(s) 308(2). In such examples, multiple instances of the first spatial feature(s) 308(1) may be removed from the memory 310 so that multiple instances of the second spatial feature(s) 308(2) may be stored in the memory 310. In other words, until the feature extractor(s) 108 processes enough images to fill the memory 310 with spatial features corresponding to the images, varying numbers of copies of different spatial features for different images may be stored in the memory 310 to keep the memory 310 full.

Referring back to the example of FIG. 1, the process 100 may include using one or more classifiers 114 to process the feature information 110 (and/or the placeholder information) stored in the memory 112 and/or newly generated feature information 110 to determine one or more classifications 116 associated with one or more objects and/or one or more attributes 118 associated with the object(s). As described herein, in some examples, the classifier(s) 114 may process the feature information 110 based on the occurrence of one or more events, such as a capacity of the memory 112 satisfying (e.g., being equal to or greater than) a threshold. For example, the classifier(s) 114 may process the feature information 110 based on the memory 112 being full. Additionally, a classifier 114 may include type of classifier, such as a CNN classifier, a temporal classifier, an artificial neural network classifier, a support vector machine classifier, and/or the like. Furthermore, the process 100 may use any number of the classifier(s) 114 to perform one or more of the processes described herein.

For a first example, the process 100 may include using a temporal classifier 114—such as a CNN classifier 114—that is configured to process the feature information 110 stored in the memory 112 and determine a classification 116 and/or the attribute(s) 118 associated with an object. For a second example, the process 100 may include using the temporal classifier 114 that is configured to process the feature information 110 stored in the memory 112 to determine the attribute(s) 118 and one or more other classifiers that are configured to process at least a portion of the feature information 110 (e.g., an instance of the feature information 110 that is associated with a frame) to determine the classification 116 of the object. While these are two example architectures for processing the feature information 110, in other examples, additional and/or alternative architectures may be used to process the feature information 110.

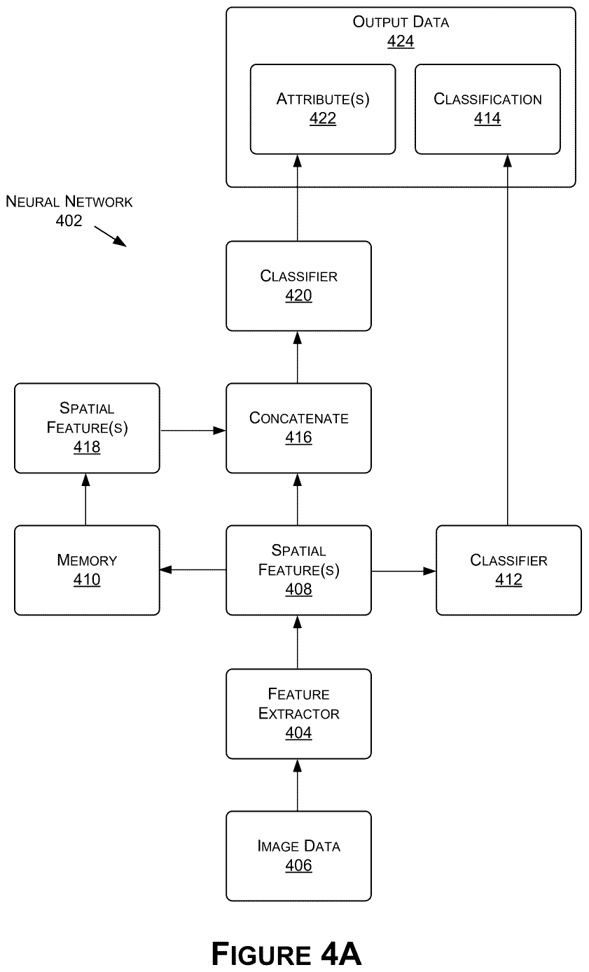

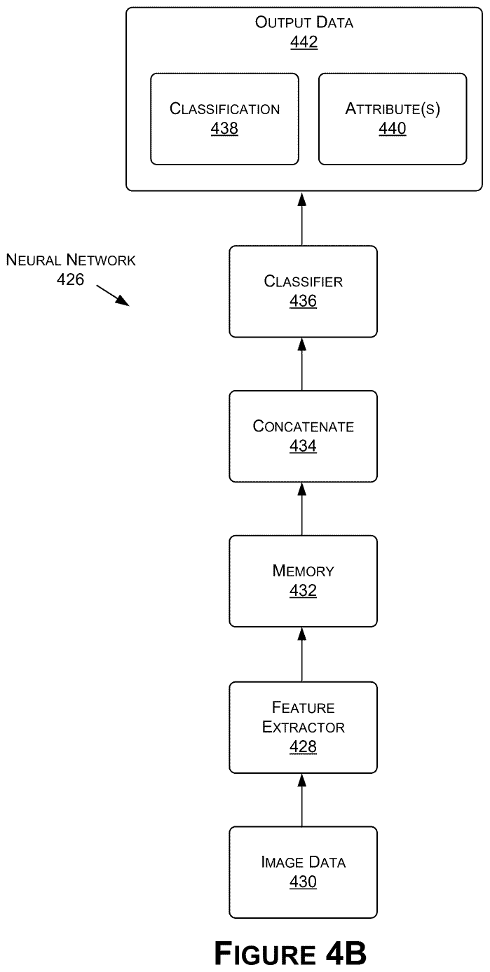

For more details, FIGS. 4A-4B illustrate examples of architectures associated with neural networks that may perform one or more of the processes described herein, in accordance with some embodiments of the present disclosure. As shown by the example of FIG. 4A, a neural network 402 may include a feature extractor 404—such as a CNN extractor (and/or any other type of extractor)—that is configured to process image data 406 representing an image to generate one or more spatial features 408 associated with the image. The spatial feature(s) 408 may then be stored in a memory 410. Additionally, the neural network 402 may include a first classifier 412—such as a CNN classifier (and/or any other type of classifier)—that is configured to process the spatial feature(s) 408 to determine a classification 414 associated with an object.

As further shown, the neural network 402 may concatenate 416 the spatial feature(s) 408 with one or more additional spatial features 418 stored in the memory 410 that are associated with one or more previously processed images. The neural network 402 may then include a second classifier 420—such as a temporal CNN classifier (and/or any other type of classifier)—that is configured to process the concatenated spatial features to determine one or more attributes 422 associated with the object. As such, the neural network 402 may generate output data 424 that represents at least the classification 414 and the attribute(s) 422 associated with the object.

Next, as shown by the example of FIG. 4B, a neural network 426 may include a feature extractor 428—such as a CNN extractor (and/or any other type of extractor)—that is configured to process image data 430 representing images to generate spatial features associated with the images, where the spatial features are stored in a memory 432. The neural network 426 may then concatenate 434 the spatial features stored in the memory 432 to generate concatenated spatial features. Additionally, the neural network 426 may include a classifier 436—such as a temporal CNN classifier (and/or any other type of classifier)—that is configured to process the concatenated spatial features to determine a classification 438 and one or more attributes 440 associated with an object. As such, the neural network 426 may generate output data 442 that represents at least the classification 438 and the attribute(s) 440 associated with the object.

Referring back to the example of FIG. 1, in some examples, a classification 116 associated with an object may include a general classification, such as vehicle, pedestrian, animal, traffic feature, structure, and/or the like. Additionally, or alternatively, in some examples, a classification 116 associated with an object may include a specific classification. For a first example, and for vehicles, a classification 116 may include car, truck, SUV, van, bus, truck, and/or any other type of vehicle. For a second example, and for traffic features, a classification 116 may include vehicle, traffic pole, traffic light, traffic signal, traffic sign, road marking, lane marking, and/or any other type of traffic feature. Additionally, an attribute 118 associated with an object may be associated with any changes that are occurring with respect to the object and/or a component of the object over a period of time. For example, an attribute 118 may include a state of a light signal of an object, a motion of the object, and/or the like.

For a first example, and for a light signal, an attribute 118 may indicate that the state of the light signal is cycling, on, off, and/or any other state. For a second example, and for a vehicle that includes multiple light signals, an attribute 118 may indicate that the state of the vehicle is turning left, turning right, reversing, stopping, emergency lighting (e.g., for emergency vehicles), hazard lighting, warning lighting, and/or performing any other action that may be indicated by the light signals of the vehicle. For a third example, and for a traffic light, an attribute 118 may indicate whether the traffic light is green, yellow, red, and/or providing any other type of light indicator. For a fourth example, and for a dynamic object, an attribute 118 may indicate motion information associated with the object, such as a velocity, an acceleration, a direction of travel, and/or any other motion information. In other words, an attribute 118 may include any characteristic of an object that may be detected over a period of time.

For example, and referring back to the example of FIG. 2, the classifier(s) 114 may process the spatial features 208 stored in the memory 210. Based at least on the processing, the classifier(s) 114 may determine that a classification associated with the object includes a vehicle, a first attribute associated with the vehicle includes the light signal 206 blinking, and/or a second attribute associated with the vehicle includes turning right (e.g., based on the light signal 206 blinking). This is because, over a period of time associated with the images 202, the images 202 may switch from depicting the light signal 206 as being in an on state to depicting the light signal 206 as being in an off state. As such, by concatenating and then processing the spatial features 208 stored in the memory 210, the classifier(s) 114 is able to more accurately determine that the light signal 206 is blinking.

Referring back to the example of FIG. 1, the process 100 may then continue to repeat in order to continue determining the classification(s) 116 and/or the attribute(s) 118 associated with the object. For instance, the process 100 may repeat for every image represented by the image data 102, every other image represented by the image data 102, every fourth image represented by the image data 102, and/or any other interval of the image data 102 to determine the classification 116 and/or the attribute(s) 118 associated with the object. This is because, in some examples, the attribute(s) 118 may change over a period of time, such as when the object performs a new maneuver. Additionally, in some examples, the process 100 may be performed to determine one or more classifications 116 and/or one or more attributes 118 associated with one or more additional objects.

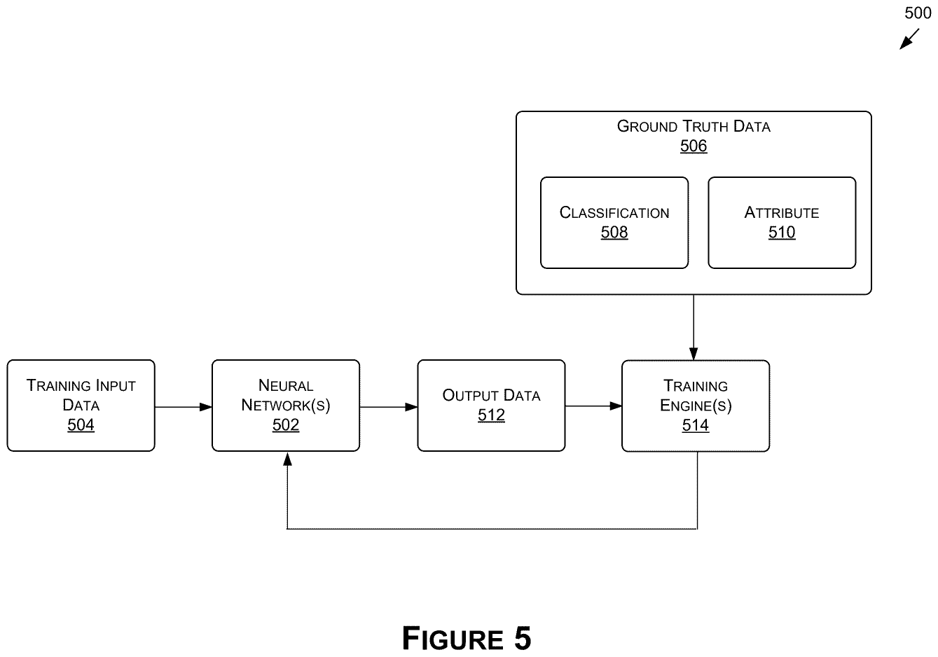

As described herein, one or more neural networks may be trained to perform at least a portion of the processing described herein, such as to determine classifications and/or attributes associated with objects. For instance, FIG. 5 illustrates an example of a process 500 for training one or more neural networks 502 to perform at least a portion of the processing described herein, in accordance with some embodiments of the present disclosure. In some examples, the neural network(s) 502 may be associated with the process 100 of FIG. 1, such as by including the feature extractor(s) 108 and the classifier(s) 114. Additionally, or alternatively, in some examples, the neural network(s) 502 may include and/or be similar to the neural network 402 from the example of FIG. 4A and/or the neural network 426 from the example of FIG. 4B.

As shown, the neural network(s) 502 may be trained using training input data 504. In some examples, the training input data 504 may represent videos of objects performing one or more actions. For a first example, the training input data 504 may represent videos of vehicles (and/or other types of machines) activating light signals. For a second example, the training input data 504 may represent videos of dynamic objects moving throughout different environments. In some examples, the training input data 504 may be real produced (e.g., obtained using one or more machines navigating within one or more environments), synthetically produced, and/or any combination thereof.

The neural network(s) 502 may be trained using the training input data 504 along with corresponding ground truth data 506. As shown, the ground truth data 506 may represent at least classifications 508 and attributes 510 associated with objects represented by the training input data 504. For a first example, if an instance of the training input data 504 represents a video depicting a vehicle using a turn signal, then the ground truth data 506 may represent the classification 508 of the object as a vehicle and the attribute 510 of the object as including the turn signal on and/or the vehicle turning. For a second example, if an instance of the training input data 504 represents a video of a pedestrian moving in a specific direction, then the ground truth data 506 may represent the classification 508 as pedestrian and the attribute 510 as including motion information associated with the pedestrian. As such, in some examples, individual instances of the training input data 504 (e.g., individual videos) may be associated with corresponding ground truth data 506. In some examples, the ground truth data 506 may be real produced, synthetically produced, human labeled, machine labeled, and/or any combination thereof.

As shown, the process 500 may include the neural network(s) 502 processing the training input data 504 to generate output data 512 corresponding to the training input data 504. For instance, the output data 512 may represent at least predicted classifications and/or predicted attributes associated with the objects represented by the training input data 504. The process 500 may then include one or more training engines 514 using one or more loss functions that measure loss (e.g., error) in the output data 512 as compared to the ground truth data 506. For instance, the loss function(s) may measure the loss based at least on differences between the predicted classifications represented by the output data 512 and the classifications 508 represented by the ground truth data 506 and/or differences between the predicted attributes represented by the output data 512 and the attributes 510 represented by the ground truth data 506. The training engine(s) 514 may then perform backward pass computations to recursively compute gradients of the loss function(s) with respect to training parameters in order to update the parameters and/or weights of the neural network(s) 502, which is indicated by the arrow from the training engine(s) 514 to the neural network(s) 502. For example, the training engine(s) 514 may update the parameters and/or weights of the feature extractor(s) and/or the classifier(s) of the neural network(s) 502.

As described herein, in some examples, one or more techniques may be used to improve the training of the neural network(s) 502. For a first example, the neural network(s) 502 may be configured to process images of videos using a specific framerate when deployed within a machine. In some examples, the framerate may be based on the target hardware in the machine, such as the image sensor(s) that generates the image data being processed by the neural network(s) 502. As such, during training, temporal random jittering may be used to provide the images to the neural network(s) 502 at one or more other framerates, such as using a framerate range that surrounds the actual framerate. For a second example, random dropping out of images may also be used, such as to simulate issues with image sensors and/or processing that may occur when executing on the machine.

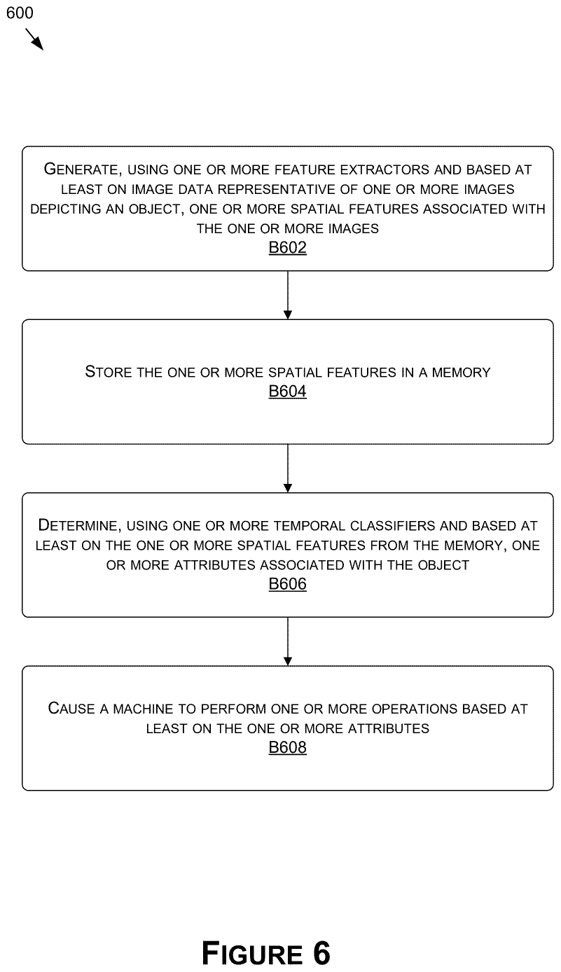

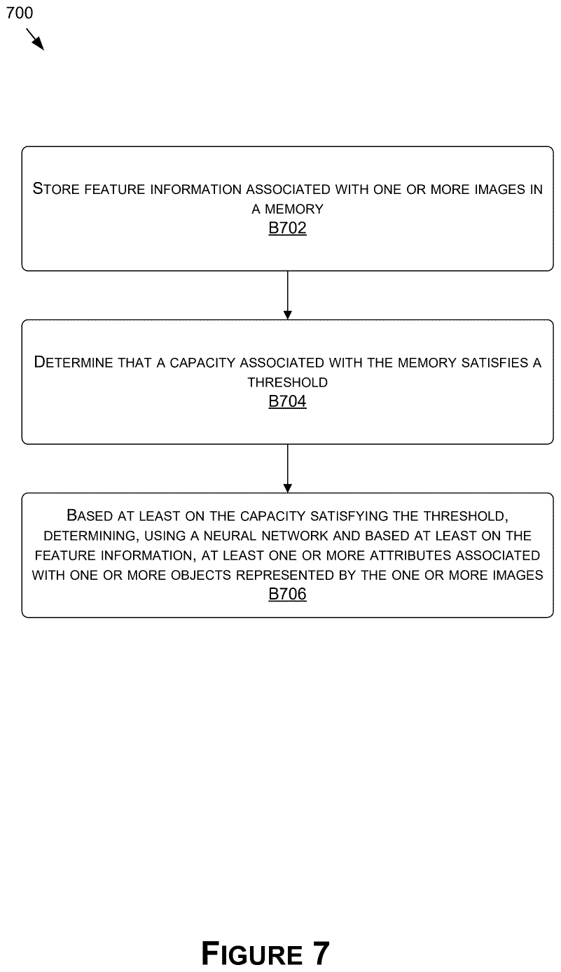

Now referring to FIGS. 6 and 7, each block of methods 600 and 700, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods 600 and 700 may be provided by a standalone application, a service or hosted service (standalone or in combination with another hosted service), an application programming interface (API) and/or a plug-in to another product, etc. In addition, the methods 600 and 700 are described, by way of example, with respect to FIG. 1. However, these methods 600 and 700 may additionally or alternatively be executed by any one system, or any combination of systems, including, but not limited to, those described herein.

FIG. 6 illustrates a flow diagram showing a method 600 for using temporal information to determine attributes associated with objects, in accordance with some embodiments of the present disclosure. The method 600, at block B602, may include generating, using one or more feature extractors and based at least on image data representative of one or more images depicting an object, one or more spatial features associated with the one or more images. For instance, the feature extractor(s) 108 may process the image data (and/or, in some examples, the processed image data 106) to generate the feature information 110 representing the spatial feature(s) associated with the image(s). As described herein, in some examples, the feature extractor(s) 108 may include a CNN extractor (and/or any other type of extractor) that is configured to perform one or more of the processes described herein.

The method 600, at block B604, may include storing the one or more spatial features in a memory. For instance, the spatial feature(s) may be stored in the memory 112. As described herein, in some examples, such as when the memory 112 is not yet full of spatial features associated with images, padding may be used to store predefined features (e.g., value features) within the memory 112. Additionally, or alternatively, in some examples, such as when the memory 112 is again not yet full of spatial features, copies of the spatial feature(s) may be generated and stored in the memory 112.

The method 600, at block B606, may include determining, using one or more temporal classifiers and based at least on the one or more spatial features from the memory, one or more attributes associated with the object. For instance, the classifier(s) 114 may process the spatial feature(s) stored in the memory 112 to determine the attribute(s) 118 associated with the object. In some examples, the classifier(s) 114 may further process the spatial feature(s) generated by the feature extractor(s) 108 and/or the spatial feature(s) stored in the memory 112 to determine a classification 116 associated with the object. As described herein, in some examples, the classifier(s) 114 may process the spatial feature(s) based on the occurrence of one or more events, such as a capacity of the memory 112 satisfying a threshold.

The method 600, at block B608, may include causing a machine to perform one or more operations based at least on the one or more attributes. For instance, the machine may determine one or more trajectories to navigate based on the attribute(s) 118. For a first example, if the attribute(s) 118 indicates a state of a light signal and/or motion associated with a vehicle—such as the object turning, reversing, and/or stopping—then the operation(s) may be associated with navigating along a trajectory that would avoid a collision with the object. For a second example, if the attribute(s) 118 indicates a state of a light signal associated with a traffic feature, such as a traffic signal or a traffic sign, then the operation(s) may be associated with navigating along a trajectory that causes the machine to follow the rules associated with the state (e.g., stopping when the traffic signal is red).

FIG. 7 illustrates a flow diagram showing a method 700 for using stored feature information to determine attributes associated with objects, in accordance with some embodiments of the present disclosure. The method 700, at block B702, may include storing feature information associated with one or more images in memory. For instance, the feature extractor(s) 108 may process the image data 102 representing the image(s) to generate the feature information 110. The feature information 110 may then be stored in the memory 112. As described herein, in some examples, additional padding information may be stored in the memory 112, such as value vectors (e.g., zero vectors, etc.). Additionally, or alternatively, in some examples, one or more copies of the feature information 110 may be generated and stored in the memory 112.

The method 700, at block B704, may include determining that a capacity associated with the memory satisfies a threshold. For instance, a determination may be made that the capacity of the memory 112 is equal to or greater than the threshold. In some examples, the threshold may include the memory 112 being full.

The method 700, at block B706, may include, based at least on the capacity satisfying the threshold, determining, using a neural network and based at least on the feature information, at least one or more attributes associated with one or more objects represented by the one or more images. For instance, based on the capacity of the memory 112 satisfying the threshold, the neural network may use the classifier(s) 114 to process the feature information 110 stored in the memory 112 to determine the attribute(s) 118 associated with the object. Additionally, in some examples, the neural network may further use the classifier(s) 114 to determine one or more classifications 116 associated with the object(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and unpiloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### EXAMPLE AUTONOMOUS OR SEMI-AUTONOMOUS MACHINE

FIG. 8A is an example of sensor locations having corresponding fields of view or sensory fields for an autonomous or semi-autonomous vehicle 800a, an autonomous mobile robot (AMR) 800b, and a humanoid robot 800c, in accordance with some embodiments of the present disclosure. Although three types of machines 800 are illustrated, this is not intended to be limiting, and the machine(s) 800 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 800a, AMR 800b, humanoid robot 800c, and/or other machine types may be referred to herein collectively as machine 800, in some instances.

With respect to vehicles 800A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 800 may be capable of functionality in accordance with one or more of Level 3-Level 5 of the autonomous driving levels. The machine 800 may be capable of functionality in accordance with one or more of Level 1-Level 5 of the autonomous driving levels. For example, the machine 800 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 800 or other machine, such as being fully autonomous, being highly autonomous, being conditionally autonomous, being partially autonomous, providing assistive autonomy, being semi-autonomous, being primarily autonomous, or other designation.

With respect to FIG. 8A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 868D, a 180 degree field of view of a wide-view camera 870, a 360 degree sensory field of a LiDAR sensor 864, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 800a, AMR 800b, and/or humanoid robot 800c, etc. For example, with respect to the vehicle 800a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 800b and/or humanoid robot 800c, the shape, size, purpose, implementation, model, etc. may dictate the number and types of sensors used.

As illustrated in FIG. 1A, the autonomous or semi-autonomous vehicle 800A, the AMR 800B, and the humanoid robot 800C may include different sensor types, number, and locations. For a non-limiting example, the vehicle 800A may include twelve cameras 864, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 864 may use, in embodiments, a gigabit multimedia serial link (GMSL) interface—such as GMSL2—as input/output (I/O).

In some embodiments, although not illustrated in FIG. 8A, the vehicle 800A may include an in-cabin occupant and/or driver monitoring system, that may include various different sensors. For example, the in-cabin sensors may include various cameras 868, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 868, the internal camera(s) 868 may, in embodiments, use a GMSL (such as GMSL2) interface for I/O.

As another non-limiting example, the vehicle 800A may further include nine RADAR sensors 860. For example, the vehicle 800A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 860 may use, in embodiments, an Ethernet interface as I/O.

The vehicle(s) 800A may further include, as a non-limiting example, twelve ultrasonic sensors 862. As illustrated in FIG. 8A, the ultrasonic sensors may be positioned along the front and rear bumpers of the vehicle 800A, and along the side of the vehicle 800A, and may be used to detect objects (static and dynamic) in close proximity to the vehicle 800A. In some embodiments, the ultrasonic sensor(s) 862 may use a DS13 interface as I/O.

The vehicle(s) 800A may further include, as a non-limiting example, a LiDAR sensor 864, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 864 may include a 360 degree horizontal FOV or sensory field (such as in a spinning LiDAR sensor) and a 90 degree vertical FOV or sensory field. In some embodiment, the LiDAR sensor(s) 864 may use an Ethernet interface as I/O.

The autonomous mobile robot (AMR) 800B may include, as a non-limiting example, three LiDAR sensors 864. For example, the top-most illustrated LiDAR sensor 864 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 800B may further include, as a non-limiting embodiment, eight cameras 868, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +−3 degree FOV), a rear fisheye camera (e.g., 202 degree +−3 degree FOV), a left fisheye camera (e.g., 202 degree +−3 degree FOV), and a right fisheye camera (e.g., 202 degree +−3 degree FOV).

The AMR 800B may further include a charging port, charging port contacts, a status indicator light, one or more (e.g., four) RGB LEDs, one or more IMU sensors 866, a magnetometer, and a barometer. The AMR 800B is capable of high-precision time synchronization between sensors using hardware time stamping, and PTP over Ethernet with less than 10 microseconds for sensor acquisition time. The AMR 800B provides simultaneous camera capture across all cameras 868 within 100 microseconds from a single hardware trigger, in embodiments, and can write to disk at 4 GB/second for sensor capture to bag writing (e.g., writing to ROSbags for the robot operation system (ROS)). As such, the AMR 800B is capable of running the ROS (such as NVIDIA's Isaac ROS), can be teleoperated (as described herein), can map an environment, and can navigate within an environment using visual cameras 868, LiDARs 864, and/or other sensor types or modalities.

The humanoid robot 800C may include, as a non-limiting example, one LiDAR sensor 864. For example, the LiDAR sensor 864 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 800C may further include, as a non-limiting embodiment, four cameras 868, such as a front stereo camera (e.g., 120 degree FOV), a rear stereo camera (e.g., 120 degree FOV), a front fisheye camera (e.g., 202 degree +−3 degree FOV), and a rear fisheye camera (e.g., 202 degree +−3 degree FOV).

The humanoid robot 800C may further include, as a non-limiting embodiment, four ultrasonic sensors 862, such as a left arm ultrasonic sensor, a right arm ultrasonic sensor, a left leg ultrasonic sensor, and right leg ultrasonic sensor.

The humanoid robot 800C may further include any number of actuators—such as to allow control and maneuverability of joints. For example, the humanoid robot 800C may include actuators that allow for various degrees of freedom (DoF) depending on the design. In a non-limiting embodiment, the humanoid robot 800C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 800C may include position and orientation sensors, such as encoders, gyroscopes, and the like, to determine the position of the robot 800C in space, allowing for location determination and movement tracking. The humanoid robot 800C may include force and pressure sensors, in embodiments, to detect environment interactions, allowing the robot 800C to grasp objects with the right force and to avoid obstacles along the way. The perception sensors (e.g., cameras, LiDARs, RADARs, ultrasonic, SONAR, etc.) may be used along with tactile sensors to allow the robot 800C to perceive objects, shapes, and textures, and to understand when touch is initiated and stopped (along with force sensors that regulate the force used during touch). As a non-limiting example, the humanoid robot 800C may have a height of about 1-2 meters (e.g., 1.7 meters or 5′6″), a weight of 50-70 kg, be capable of moving at a speed of 8 or more km/h, and be able to carry payloads anywhere from 20-100 kg, depending on the design and requirements of the system.

The humanoid robot 800C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 800C may use onboard sensors, microphones, and speakers to understanding speech, audio and visual cues, etc., while also being able to communicate back to the environment.

With reference to cameras 868 of the machine(s) 800, the camera types for the cameras 868 may include, but are not limited to, digital cameras that may be adapted for use with the components and/or systems of the machine 800. For a vehicle 800a implementation, the camera(s) 868 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 868B that may be used to perceive objects coming into view from the periphery (e.g., pedestrians, warehouse vehicles, other robots, crossing traffic, or bicycles). In addition, any number of long-range camera(s) 868E (e.g., a long-view stereo camera pair) may be used for depth-based object detection, especially for objects for which a neural network has not yet been trained. The long-range camera(s) 868E may also be used for object detection and classification, as well as basic object tracking.

Any number of stereo cameras 868A may also be included in a front-facing and/or other (e.g., rear-facing) configuration. In at least one embodiment, one or more of stereo camera(s) 868A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 800 environment, including a distance estimate for points in the image (e.g., a disparity or depth image). An alternative stereo camera(s) 868A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 800 (e.g., side-view cameras) may be used, for example, for surround view, providing information used to create and update the occupancy grid, as well as to generate side impact collision warnings and/or to indicate to an AMR 800B or humanoid robot 800C, for example, that there are objects, features, and/or persons present to the side. For example, surround camera(s) 868D may be positioned on the machine 800. The surround camera(s) 868D may include wide-view camera(s) 868B, fisheye camera(s), 360 degree camera(s), and/or the like. For example, four fisheye cameras may be positioned on the machine's 800 front, rear, and sides. In an alternative arrangement, the machine 800 may use three surround camera(s) 868D (e.g., left, right, and rear), and may leverage one or more other camera(s) (e.g., a forward-facing camera) as a fourth surround view camera.

Cameras 868 with a field of view that include portions of the environment to the rear of the machine 800 (e.g., rear-view cameras) may be used for gaining an understanding of objects, features, persons, and/or other information to the rear of the machine 800, such as for park assistance, surround view, rear collision warnings, planning, control, and navigation determinations, and/or creating and updating an occupancy grid, BEV image representing the environment, height map, etc. A wide variety of cameras 868 may be used including, but not limited to, cameras 868 that are also suitable as a front-facing camera(s) (e.g., long-range and/or mid-range camera(s) 868E, stereo camera(s) 868A), infrared camera(s) 868C, etc.), rear-facing camera(s), side-facing camera(s), downward facing camera(s), upward facing camera(s), and/or the like, as described herein.

Similarly, for LiDAR sensors 864, RADAR sensors 860, ultrasonic sensors 862, and/or other sensor modalities or types, the location and placement of the sensors, and their corresponding fields of view or sensory fields may be determined based on the use case, implementation, or design of the particular machine 800.

For example, the machine(s) 800 include RADAR sensor(s) 860 that may be used by the machine 800 for long-range object detection, even in darkness and/or severe weather conditions. RADAR functional safety levels may be ASIL B, in embodiments. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250m range. The RADAR sensor(s) 860 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 800 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 860 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 800 (e.g., vehicle, robot, etc.). As such, short-range RADAR systems may be used in an ADAS system for blind spot detection and/or lane change assist.

The machine 800 may further include ultrasonic sensor(s) 862. The ultrasonic sensor(s) 862, which may be positioned at the front, back, and/or the sides of the machine 800, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 800. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B, as an example.

The machine 800 may include LiDAR sensor(s) 864. The LiDAR sensor(s) 864 may be used for object and feature detection, pedestrian and other robot detection, emergency braking, collision avoidance, simultaneous localization and mapping (SLAM), free-space detection, and/or other functions. The LiDAR sensor(s) 864 may be functional safety level ASIL B, in embodiments. In some examples, the machine 800 may include multiple LiDAR sensors 864 (e.g., two, four, six, etc.) that may use Ethernet (e.g., to provide data to a Gigabit Ethernet switch).

In some examples, the LiDAR sensor(s) 864 may be capable of providing a list of objects and their distances for a 360-degree field of view. Commercially available LiDAR sensor(s) 864 may have an advertised range of approximately 800 m, with an accuracy of 2 cm-3 cm, and with support for a 800 Mbps Ethernet connection, for example. In some examples, one or more non-protruding LiDAR sensors 864 may be used. In such examples, the LiDAR sensor(s) 864 may be implemented as a small device that may be embedded into the front, rear, sides, top, and/or corners of the machine 800. The LiDAR sensor(s) 864, in such examples, may provide up to a 120-degree horizontal and 35-degree vertical field-of-view, with a 200 m range even for low-reflectivity objects. Front-mounted LiDAR sensor(s) 864 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 800. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 864 may be less susceptible to motion blur, vibration, and/or shock.

FIG. 8B is an illustration of sensor and component locations of an example autonomous or semi-autonomous vehicle 800A (alternatively referred to herein as “vehicle 800,” “ego-vehicle 800,” “ego-machine 800,” or “machine 800,”), in accordance with some embodiments of the present disclosure. Although the vehicle 800A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 8C is a block diagram of an example system architecture for a machine 800, such as autonomous or semi-autonomous vehicle 800A, autonomous mobile robot (AMR) 800B, humanoid robot 800C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

Each of the components, features, and systems of the machine 800 in FIG. 8C are illustrated as being connected via bus 802 (alternatively referred to as a “machine communications network 802,” or just “communications network 802”). The bus 802 may include a Controller Area Network (CAN) data interface (alternatively referred to herein as a “CAN bus”). A CAN may be a network inside the machine 800 used to aid in control of various features and functionality of the machine 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 802 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the machine 800, and two or more busses 802 may communicate with the same components. In some examples, each SoC 804, each controller 836, and/or each computer or compute engine within the machine 800 may have access to the same input data (e.g., inputs from sensors of the machine 800), and may be connected to a common bus, such as a CAN bus.

The machine 800 may include components such as a chassis, a vehicle body, wheels (e.g., 2, 4, 6, 8, 18, etc.), tires, axles, batteries, side-view mirrors, and/or other components of a vehicle or machine. The machine 800 may include a propulsion system 850, such as an internal combustion engine, hybrid electric power plant, an all-electric engine, a hydrogen-fueled engine, and/or another propulsion system type. The propulsion system 850 may be connected to a drive train of the machine 800, which may include a transmission, to enable the propulsion of the machine 800. The propulsion system 850 may be controlled in response to receiving signals from the throttle/accelerator 852.

A steering system 854, which may include a steering wheel and/or other steering device (e.g., remote steering and/or local steering), may be used to steer the machine 800 (e.g., along a desired path or route) when the propulsion system 850 is operating (e.g., when the vehicle is in motion). The steering system 854 may receive signals from a steering actuator 856. In some embodiments, a steering wheel or other steering mechanism may not be included, such as for a machine 800 capable of full automation (e.g., Level 5) functionality.

The brake sensor system 846 may be used to operate the vehicle brakes in response to receiving signals from the brake actuators 848 and/or brake sensors.

The machine 800 may include one or more controller(s) 836, such as those described herein with respect to FIG. 8A. The controller(s) 836 may be used for a variety of functions, and may be coupled to any of the various other components and systems of the machine 800. For example, the controllers 836 may be used for control of the machine 800, artificial intelligence executing on the machine 800, infotainment for the machine 800, and/or the like. For example, one controller 836 may be used for some or all of the functionality, or different controllers 836 may be used for different functionalities—e.g., to ensure availability and a safety separation between various controllers for different tasks. For example, the controller(s) 836 may use plans computed by the system—e.g., paths or trajectories for vehicles 800A or AMRs 800B, or movements, components trajectories, movement locations or displacements, etc. for joints or components (e.g., of manipulators, end effectors, limbs, hands, fingers, legs, feet, etc.), of a humanoid robot 800C—to control the machine(s) 800 in the environment. In some instances, the controller(s) 836 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 800C, for example, the controller(s) 836 may act as the brain, responsible for analyzing sensor data, making decisions, and sending commands to the actuators. The controller(s) 836 may include a low-level controller that handles basic motor control, ensuring accurate and precise movements of individual joints and actuators. The controller(s) 836 may include a high-level controller to coordinate multiple actuators and sensors, planning complex motions and adapting to changing environments.

The controller(s) 836 may include an artificial intelligence controller, in embodiments, that may use AI algorithms (e.g., DNNs, MLMs, etc.) to learn, make decisions, and autonomously perform tasks for the machine 800. In some embodiments, the controller(s) 836 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 836 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 836, which may include one or more systems on chip (SoCs) 804 (FIGS. 8C and 8D), CPUs, GPU(s), accelerator(s), etc., may provide signals (e.g., representative of commands or messages) to one or more components and/or systems of the machine 800. Although the controller(s) 836 is listed separately from the SoC(s) 804, this is not intended to be limiting, and in some embodiments one or more components of the SoC(s) 804 may perform the operations of the controller(s) 836. For example, the controller(s) may send signals to operate the machine brakes via one or more brake actuators 848, to operate the steering system 854 via one or more steering actuators 856, to operate the propulsion system 850 via one or more throttle/accelerators 852, etc. The controller(s) 836 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 800. The controller(s) 836 may include a first controller 836 for autonomous control and navigation functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 836 may handle two or more of the above functionalities, two or more controllers 836 may handle a single functionality, and/or any combination thereof.

The controller(s) 836 may provide the signals for controlling one or more components and/or systems of the machine 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LiDAR sensor(s) 864, inertial measurement unit (IMU) sensor(s) 866 (e.g., accelerometer(s), gyroscope(s), magnetic compass(es), magnetometer(s), etc.), microphone(s) 896, camera(s) 868 (e.g., stereo camera(s) 868A, wide-view camera(s) 868B (e.g., fisheye cameras), infrared camera(s) 868C, surround camera(s) 868D (e.g., 360 degree cameras), long-range and/or mid-range camera(s) 868E, and/or other camera types), speed sensor(s) 844 (e.g., for measuring the speed of the machine 800), vibration sensor(s) 842, steering sensor(s) 840, brake sensor(s) (e.g., as part of the brake sensor system 846), actuators, and/or other sensor types.

One or more of the controller(s) 836 may receive inputs (e.g., represented by input data) from an instrument cluster 832 of the machine 800 and provide outputs (e.g., represented by output data, display data, etc.) via a human-machine interface (HMI) display 834 (e.g., screen, heads-up display, mirror display, facial display, robotic display, etc.), an audible annunciator, a loudspeaker, a speaker, and/or via other components of the machine 800. The outputs may include information such as machine velocity, speed, time, map data corresponding to a map(s) 822 of FIG. 8C (e.g., from a navigation map, a Standard Definition (SD) map, a High Definition (“HD”) map, etc.), location data (e.g., the machine's 800 location, such as on a map 822), direction, location of other vehicles (e.g., an occupancy map, height map, bird's eye view (BEV) image, grid, etc.), information about objects and status of objects as perceived by the system, system status information, etc. For example, the HMI display(s) 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 800 may include one or more systems on a chip (SoCs) 804 (described in more detail in FIG. 8D). The SoC(s) 804 may include CPU(s) 806, GPU(s) 808, processor(s) 810, cache(s) 812, accelerator(s) 814, data store(s) 816, and/or other components and features. The SoC(s) 804 may be used to process and provide data for various operations, such as navigation, planning, reasoning, inference, perception, control, and/or actuation operations of the machine 800 in a variety of platforms and systems. For example, the SoC(s) 804 may process live perception data (e.g., from camera, LiDAR, RADAR, ultrasonic, etc.) in addition to map data corresponding to one or more maps 822 (e.g., HD map, SD map, navigational map, occupancy map, etc.) in order to make or aid in performing various operations of the machine 800. Where a map and/or AI is used, map and/or AI (e.g., model parameter updates, fine-tuning, etc.) refreshes and/or updates via a network interface 824 from one or more servers (e.g., server(s) 878 of FIG. 8E)—such as one or more servers of a cloud-based data center.

Although an SoC(s) 804 is illustrated throughout FIGS. 8A-8E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 800, use of the machine 800, model of the machine 800, and required capabilities of the machine 800, one or more SoCs 804 and/or alternative architectures and/or components may be used to satisfy the particular implementation.

The machine 800 may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The machine 800 may include a GPU(s) 820 (e.g., discrete GPU(s), or dGPU(s)), that may be coupled to the SoC(s) 804 via a high-speed interconnect (e.g., NVIDIA's NVLink). The GPU(s) 820 may provide additional artificial intelligence functionality, such as by executing redundant and/or different neural networks, and may be used to train and/or update neural networks based on input (e.g., sensor data) from sensors of the machine 800.

The machine 800 may further include the network interface 824 which may include one or more wireless antennas 826 and/or modems (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 800 information about vehicles in proximity to the machine 800 (e.g., vehicles in front of, on the side of, and/or behind the machine 800). This functionality may be part of a cooperative adaptive cruise control functionality of the machine 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The machine 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The machine 800 may further include IMU sensor(s) 866. The IMU sensor(s) 866 may be located at a center of the rear axle of the machine 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the machine 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include one or more microphone 896 placed in and/or around the machine 800. The microphone(s) 896 may be used for emergency vehicle detection and identification, among other things.

The machine 800 may further include vibration sensor(s) 842. The vibration sensor(s) 842 may measure vibrations of components of the machine, such as the arms or legs of a humanoid robot 800C, or the axle(s) of a vehicle 800A or AMR 800B. For example, changes in vibrations may indicate a change in road, walking, or traversable surfaces. In another example, when two or more vibration sensors 842 are used, the differences between the vibrations may be used to determine friction or slippage of the surface (e.g., when the difference in vibration is between a power-driven axle and a freely rotating axle).

The machine 800 may include an ADAS system 838—such as when the machine 800 is a vehicle 800A. The ADAS system 838 may include a dedicated SoC(s), in some examples. The ADAS system 838 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 800 may further include the infotainment SoC 830 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the machine 800. In some examples, the infotainment SoC 830 may be coupled to a supervisory MCU such that the GPU of the infotainment system may perform some self-driving functions in the event that the primary controller(s) 836 (e.g., the primary and/or backup computers of the machine 800) fail. In such an example, the infotainment SoC 830 may put the machine 800 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 800—whether a vehicle 800A, AMR 800B, humanoid robot 800C, and/or other type of machine—may include a locally stored language model(s) and/or communicate to a remotely hosted language model (e.g., via one or more APIs) to provide more detailed and in-depth communication features to the users of the machine(s) 800.

In some examples, an infotainment SoC 830, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 800.

The machine 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a block diagram of an example architecture of a computing system (a subset of the system described with respect to FIG. 8C), in accordance with at least some embodiments of the present disclosure. Although illustrated as an SoC(s) 804, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 804 may be an end-to-end platform with a flexible architecture that spans automation levels 2-5, or the SoC(s) 804 may be specifically designed for a specific automation level (e.g., a first SoC 804 for level 2 to level 2++, a second SoC 804 for level 3, a third SoC 804 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 2-5 autonomous vehicles as well as for safe planning, navigation, and control of AMRs 800B, humanoid robots 800C, and/or other robot or machine types.

In some embodiments, such as where the SoC(s) 804 include a GPU 808 with 2000 or more cores (e.g., 2048 cores), 60 or more tensor cores (e.g., 64 tensor cores), and a GPU max frequency of over 1 GHz (e.g., 1.3 GHz), a CPU 806 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 809 (e.g., 2 DLAs/XNNs/NNAs/NPUs 809), and a vision accelerator—such as a programmable vision accelerator (PVA) 807, a single SoC 804) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 804 include a GPU 808 with 1700 or more cores (e.g., 1792 cores), 50 or more tensor cores (e.g., 56 tensor cores), and a GPU max frequency of over 900 MHz (e.g., 930 MHz), a CPU 806 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 809 (e.g., 2 DLAs/XNNs/NNAs/NPUs 809), and a vision accelerator—such as a programmable vision accelerator (PVA) 807, a single SoC 804) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 804 include a GPU 808 with 1000or more cores (e.g., 1024 cores), 28 or more tensor cores (e.g., 32 tensor cores), and a GPU max frequency of over 900 MHz (e.g., 1173 MHz), a CPU 806 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 809 (e.g., 1 DLA/XNN/NNA/NPU 809), and a vision accelerator—such as a programmable vision accelerator (PVA) 807, a single SoC 804) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 804 include a GPU 808 with 1000 or more cores (e.g., 1024 cores), 28 or more tensor cores (e.g., 32 tensor cores), and a GPU max frequency of over 900 MHz (e.g., 1020 MHz), a CPU 806 including 6 or more cores (e.g., 6 cores), with 64 bits, 1.5 MB L2 and 4 MB L3 cache memory, and a max frequency of 1.5 or more GHz (e.g., 1.7 GHz), a single SoC 804) may be capable of 67 tera operations per second (TOPS) of AI performance. For example, NVIDIA's Jetson Orin Nano 8 GB SoC satisfies these criteria, and achieves this performance.

The SoC(s) 804 may include one or more CPUs 806. The CPU(s) 806 may include a CPU cluster or CPU complex (alternatively referred to herein as a “CCPLEX”), in embodiments. The CPU(s) 806 may include multiple cores and/or (e.g., L2, L3) caches. For example, in some embodiments, the CPU(s) 806 may include twelve cores in a coherent multi-processor configuration. In some embodiments, the CPU(s) 806 may include four dual-core clusters where each cluster has a dedicated L2 cache (e.g., a 3 MB L2 cache). The CPU(s) 806 (e.g., the CCPLEX) may be configured to support simultaneous cluster operation enabling any combination of the clusters of the CPU(s) 806 to be active at any given time.

The SoC(s) 804 may include any type and number of GPUs 808. For example, an integrated GPU(s) (alternatively referred to herein as an “iGPU(s)”) may be used in some embodiments. The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive, robotics, and/or other embedded use cases. For example, the GPU(s) 808 may be fabricated on a Fin field-effect transistor (FinFET). However, this is not intended to be limiting and the GPU(s) 808 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

The SoC(s) 804 may include any number of cache(s) 812, including those described herein. For example, the cache(s) 812 may include L0 caches, L1 caches, L2 caches, L3 caches (e.g., that are available to both the CPU(s) 806 and the GPU(s) 808 (e.g., that is connected both the CPU(s) 806 and the GPU(s) 808)), etc. The cache(s) 812 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 804 may include one or more arithmetic logic units (ALUs) 865 which may be leveraged in performing processing with respect to any of the variety of tasks or operations of the machine 800—such as computer vision, machine learning or deep learning processing, world model management, etc. In addition, the SoC(s) 804 may include a floating point unit(s) (FPU(s)) 867—or other math coprocessor or numeric coprocessor types—for performing mathematical operations within the system. For example, the SoC(s) 104 may include one or more FPUs 867 integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory 815 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 814 (e.g., the hardware acceleration cluster) may include a deep learning accelerator(s) (DLA) 809 (alternatively referred to herein as “a deep learning accelerator cluster (XNN) 809,” “neural network accelerator (NNA) 809,” or “neural processing unit (NPU) 809”). The DLA(s) 809 may include one or more Tensor processing units (TPUs) 841 that may be configured to provide an additional, e.g., ten trillion operations per second for deep learning applications and inferencing. The TPUs 841 may be accelerators configured to, and optimized for, performing image processing functions (e.g., for CNNs, RCNNs, DNNs, etc.). The DLA(s) 809 may further be optimized for a specific set of neural network types and floating point operations, as well as inferencing. The design of the DLA(s) may provide more performance per millimeter than a general-purpose GPU, and vastly exceeds the performance of a CPU. The TPU(s) 841 may perform several functions, including a single-instance convolution function, supporting, for example, INT8, INT16, and FP16 data types for both features and weights, as well as post-processor functions. Although the TPU(s) 841 are described as being included as part of the DLA(s) 809, this is not intended to be limiting, and the TPU(s) 841 may be included in additional or alternative accelerator(s) 814 and/or other components, and/or may be included as a discrete processing component(s).

The DLA(s) 809 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 809 may perform any function of the GPU(s) 808, and by using an inference accelerator, for example, a designer may target either the DLA(s) 809 or the GPU(s) 808 for any function. For example, the designer may focus processing of DNNs and floating point operations on the DLA(s) 809 and leave other functions to the GPU(s) 808 and/or other accelerator(s) 814. The DLA(s) 809 may be used to run any type of network to enhance control and safety, including for example, a neural network that outputs a measure of confidence for each object detection.

The accelerator(s) 814 (e.g., the hardware acceleration cluster) may include a programmable vision accelerator(s) (PVA) 807, which may alternatively be referred to herein as a computer vision accelerator or generally a vision accelerator. The PVA(s) 807 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 807 may provide a balance between performance and flexibility. For example, each PVA(s) 807 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 807 may be optimized for the tasks of image processing and computer vision algorithm acceleration. For example, the PVA(s) 807 provides excellent performance with extremely low power consumption, and can be used asynchronously and concurrently with the CPU(s) 806, GPU(s) 808, and/or other accelerators in the system (e.g., vehicle, robot, etc.) as part of a heterogeneous compute pipeline.

The PVA(s) 807 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 843 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 806 (e.g., ARM Cortex-R5 processor), facilitating data exchange with the CPU(s) 806 and other system-level components. The VPU I-cache may supply instruction data to the VPU(s) when requested, may request missing instruction data from system memory, and/or may maintain temporary instruction storage for the VPU. For each VPU task, the CPU(s) 806 may configures the DMA system, optionally prefetch the VPU program into VPU I-cache, and/or kick off each VPU-DMA pair to process a task. The PVA(s) 807 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP 32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 807 to access the system memory independently of the CPU(s) 806. The DMA may support any number of features used to provide optimization to the PVA(s) 807 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 807 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 807, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 807 may be configured to employ data parallelism. For example, in some embodiments, the plurality of vector processors included in a single PVA(s) 807 may execute the same computer vision algorithm, but on different regions of an image. In other examples, the vector processors included in a particular PVA(s) 807 may simultaneously execute different computer vision algorithms, on the same image, or even execute different algorithms on sequential images or portions of an image. Among other things, any number of PVAs 807 may be included in the hardware acceleration cluster and any number of vector processors may be included in each of the PVAs. In addition, the PVA(s) 807 may include additional error correcting code (ECC) memory, to enhance overall system safety.

The accelerator(s) 814 (e.g., the hardware accelerator cluster) have a wide array of uses for autonomous and semi-autonomous machine control. The PVA(s) 807 may be a programmable vision accelerator that may be used for key processing stages in perception, robotics understanding and reasoning, ADAS, semi-autonomous, and autonomous vehicles, etc. The PVA's 807 capabilities are a good match for algorithmic domains needing predictable processing, at low power and low latency. In other words, the PVA(s) 807 performs well on semi-dense or dense regular computation, even on small data sets, which need predictable run-times with low latency and low power. Thus, in the context of platforms for autonomous vehicles and robotics, the PVAs 807 are designed to run classic computer vision algorithms, as they are efficient at object detection and operating on integer math.

For example, according to one embodiment of the technology, the PVA 807 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 807 may perform computer stereo vision function on inputs from two monocular cameras.

In some examples, the PVA(s) 807 may be used to perform dense optical flow. According to process raw RADAR data (e.g., using a 4D Fast Fourier Transform) to provide Processed RADAR. In other examples, the PVA(s) 807 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 807, this is not intended to be limiting. In some embodiments, these components may be included in alternative or additional processing components and/or accelerator(s) 814, and/or may be included as discrete components of the SoC(s) 804 and/or other computing system architecture(s).

In some examples, the SoC(s) 804 may include a real-time ray-tracing hardware accelerator (RTA) 851 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 800 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 851 and/or a ray-tracing optimized GPU 806—such as NVIDIA's RTX GPU.

The accelerator(s) 814 (e.g., in the hardware acceleration cluster) may include one or more optical flow accelerators (OFAs) 811. For example, the OFA(s) 811 may be used for computing optical flow and stereo disparity between frames of sensor data (e.g., images). Optical flow may be accelerated on the OFA(s) 811 for uses such as object detection and tracking, and/or for stereo depth estimation where used for computing stereo disparity between stereo image frames (e.g., two or more frames captured using two or more image sensors with at least partially overlapping fields of view).

The SoC(s) 804 may include one or more camera serial interfaces (CSIs) 823. For example, the CSI(s) 823 may include a mobile industry processor interface (MIPI) camera serial interface (CSI) for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role. For example, the CSI 823 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 814 (e.g., the hardware acceleration cluster) may include a computer vision network on-chip (CVNOC) 863 and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by the PVA 807, OFA 811, DLA 809, and/or other accelerator(s) 814. Each pair of memory blocks may include an advanced peripheral bus (APB) interface, configuration circuitry, a controller, and a multiplexer. Any type of memory 815 may be used. The PVA 807, OFA 811, DLA 809, and/or other accelerator(s) 814 may access the memory via a backbone that provides the accelerator(s) 814 with high-speed access to memory. The backbone may include a computer vision network on-chip that interconnects the accelerator(s) 814 to the memory (e.g., using the APB).

The CVNOC 863 may include an interface that determines, before transmission of any control signal/address/data, that the accelerator(s) 814 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 804 may include data store(s) 816 and/or memory 815. The data store(s) 816 may be on-chip memory 815 of the SoC(s) 804, which may store neural networks and/or other algorithms to be executed on the CPU(s) 806, the GPU(s) 808, and/or one or more of the accelerator(s) 814. In some examples, the data store(s) 816 may be large enough in capacity to store multiple instances of neural networks for redundancy and safety. The data store(s) 812 may comprise L2 and/or L3 cache(s) 812, for example. The memory(ies) 815 may include SRAM, LPDDR5, and/or other memory types. For example, the memory(ies) 815 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 816 may include reference to the memory associated with the PVA 807, OFA 811, DLA 809, and/or other accelerator(s) 814, as described herein.

The data store(s) 116 may include various storage types, such as eMMC, NVMe, etc. For example, the SoC(s) 804 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 816 and/or other storage may be accessed via, e.g., NVMe, using PCI Express (PCIe), RDMA, TCP, and/or other protocols.

The SoC(s) 804 may include one or more processor(s) 810 (e.g., embedded processors). The processor(s) 810 may include a boot and power management processor (BPMP) 853, that may be a dedicated processor and subsystem to handle boot power and management functions and related security enforcement. The BPMP 853 may be a part of the SoC(s) 804 boot sequence and may provide runtime power management services. The BPMP 853 may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, accelerator(s) 814, and/or other components. If temperatures are determined to exceed a threshold, BPMP 853 may enter a temperature fault routine and put the SoC(s) 804 into a lower power state and/or put the machine 800 into a chauffeur to safe stop mode (e.g., bring the machine 800 to a safe stop).

The processor(s) 810 may further include a set of embedded processors that may serve as an audio processing engine (APE) 855. The APE 855 may be an audio subsystem that enables full hardware support for multi-channel audio over multiple interfaces, and a broad and flexible range of audio I/O interfaces. In some examples, the APE 855 is a dedicated processor core with a digital signal processor with dedicated RAM.

The processor(s) 810 may further include an always on processor engine (AOPE) 857 that may provide necessary hardware features to support low power sensor management and wake use cases. The AOPE 857 may include a processor core, a tightly coupled RAM, supporting peripherals (e.g., timers and interrupt controllers), various I/O controller peripherals, and routing logic.

The processor(s) 810 may further include a safety processor(s) 813 (alternatively referred to as “safety island 813”), which may include a safety cluster engine that includes a dedicated processor or processor subsystem to handle safety management for automotive, robotics, and/or other applications. The safety processor(s) 813—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 813 may include a discrete processor(s), such that fault of other system components may not impact the performance and availability of the safety processor 813.

The processor(s) 810 may further include a real-time or near real-time sensor engine (SE) 859 that may include a dedicated processor subsystem for handling real-time or near real-time camera, LiDAR, RADAR, and/or other sensor modality management.

The processor(s) 810 may further include one or more image signal processors (ISPs) 827, which may include a high-dynamic range signal processor and/or a hardware engine that is part of one or more sensor processing pipelines.

The processor(s) 810 may include a video image compositor (VIC) 861 that may be a processing block (e.g., implemented on a microprocessor) that implements video post-processing functions needed by a video playback application to produce the final image for the player window. The VIC 861 may perform lens distortion correction on wide-view camera(s) 868B, surround camera(s) 868D, in-cabin monitoring camera sensors, and/or other camera sensors with distorted fields of view.

A VIC 861 may include enhanced temporal noise reduction for both spatial and temporal noise reduction. For example, where motion occurs in a video, the noise reduction weights feature information appropriately, decreasing the weight of information provided by adjacent frames. Where an image or portion of an image does not include motion, the temporal noise reduction performed by the video image compositor may use information from the previous image to reduce noise in the current image.

A VIC 861 may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a broad range of peripheral interfaces for input/output (I/O) 825, such as to enable communication with peripherals, audio codecs, power management, and/or other devices. The SoC(s) 804 may be used to process data from cameras (e.g., connected over Gigabit Multimedia Serial Link and/or Ethernet), sensors (e.g., LiDAR sensor(s) 864, RADAR sensor(s) 860, etc. that may be connected over Ethernet), data from bus 802 (e.g., speed of machine 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks. In some embodiments, the SoC(s) 804 I/O 825 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 825 elements, components, or features.

The SoC(s) 804 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 804 may include an RJ45 connector with up to 10 GbE, a 1 GbE connector, and/or other networking connector types.

The SoC(s) 104 may include one or more digital signal processors (DSPs) 843. For example, the DSP(s) 843 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 804 may include one or more video encoders 819 and/or one or more video decoders 821. For example, the video encoder(s) 819 may include a hardware-based (e.g., as part of the GPU(s) 808) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 821 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 821 may be hardware-based (e.g., as part of the GPU(s) 808).

The SoC(s) 804 may include one or more general compute acceleration clusters (GCAC(s)) 829. For example, the GCAC(s) 829 may include various processor types that may be used to accelerate compute, such as one or more vector microcode processors (VMPs) 833, one or more multi-threaded processing clusters (MPCs) 831, one or more programmable macro arrays (PMA(s)) 835, and/or one or more other processor types. For example, the GCAC(s) 829 may include a PMA 835, two VMPs 833, and 2 MPCs 831.

The SoC(s) 804 may include one or more vector microcode processors (VMPs) 833. The VMP(s) 833, in embodiments, may include a wide vector (very long instruction word (VLIW) and single instruction multiple data (SIMD)) machine with performing various operations, such as short integral type operations common in computer vision and deep learning algorithms.

The SoC(s) 804 may include one or more multi-threaded processing clusters (MPCs) 831. The MPC(s) 831 may include a processing cluster that be, in embodiments, more versatile than a GPU, and with higher efficiency than a CPU. For example, the MPC(s) 831 may include a multi-threaded processor that allows multiple threads to share resources and execute instructions concurrently.

The SoC(s) 804 may include one or more programmable macro arrays (PMA(s)) 835. The PMA(s) 835 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 804 may include one or more display processing units (DPUs) 845 for performing hardware-accelerated image processing. For example, the DPU(s) 845 may retrieve pixel data from memory 815 and send it to a display peripheral through standard interfaces. As such, the DPU(s) 845 may handle display processing and rendering for in-machine and/or on-machine displays.

The SoC(s) 804 may include one or more application processing units (APUs) 839. For example, the APU(s) 839 may include a quad or dual-core processor with 48 KB/32 KB L1 cache with parity and ECC, along with a 1 MB L2 cache with ECC. The APU(s) 839 may support NEON instructions and single and double precision floating point operations.

The SoC(s) 804 may include one or more real-time processing units (RTPUs) 869. The RTPU(s) 869 may include a dual-core processor with 32 KB/32 KB L1 cache, and 256 KB TCM with ECC. The RTPU(s) 869 may support single and double precision floating point operations.

The SoC(s) 804 may include one or more built-in self-test (BIST) components 837. For example, the BIST component(s) 837 may include memory BIST (MBIST) to test memories of the system and/or logic BIST (LBIST) to test logic of the system. The BIST components 837 may include embedded logic for directly testing logic and/or memory of the system.

The SoC(s) 804 may include one or more dynamically reconfigurable processors (DRPs) 871. For example, the DRP(s) 871 may be used for accelerating various computing operations. For example, the DRP(s) 871 may be combined, in embodiments, with a MAC unit for use as an AI accelerator. In embodiments, the DRP(s) 871 may execute applications while dynamically switching the circuit connection configuration of the arithmetic units (e.g., ALUs) on the chip at each operating clock according to the content to be processed. Since only the necessary arithmetic circuits are used, the DRP(s) 871 may consume less power than with CPU processing and can achieve higher speed. Furthermore, compared to CPUs, where frequent external memory accesses due to cache misses and other causes will degrade performance, the DRP(s) 871 can build the necessary data paths in hardware ahead of time, resulting in less performance degradation and less variation in operating speed (jitter) due to memory accesses. The DRP(s) 871 may include a dynamic loading function that switches the circuit connection information each time the algorithm changes, enabling processing with limited hardware resources, even in robotic/automotive applications that require processing of multiple algorithms.

In some embodiments, the accelerator(s) 814 may include an OpenCV accelerator for speeding up processing of OpenCV, an open-source industry standard library for computer vision processing. In some embodiments, the combination of one or more DRP(s) 871 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 804 may include various compute engines (e.g., processors 810, CPUs 806, GPU(s) 808, accelerator(s) 814, etc.), tasks may be distributed between and among the compute engines, in some instances without common cause failures due to the discrete footprint of the compute engines. Further, because the SoC(s) 804 may include a dedicated safety processor(s) 813 (or safety island 813), critical safety or redundant operations may be performed without common cause failures from the main processing components or compute engines of the SoC(s) 814. Due to these features, the SoC(s) 804 and/or the underlying systems of the machine 800 may be capable of satisfying higher levels of safety—such as automotive safety integrity level (ASIL) D from the ISO 26262 standard.

FIG. 8E is a system diagram for communication between a cloud-based server(s) (e.g., in a data center, such as those described herein) and the example autonomous or semi-autonomous vehicle or machine 800 of FIG. 8A, in accordance with some embodiments of the present disclosure. The system 876 may include a server(s) 878, a network(s) 890, and a machine(s) 800. The server(s) 878 may include a plurality of GPUs 884(A)-884(H) (collectively referred to herein as GPUs 884), switches 882(A)-882(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 880(A)-880(B) (collectively referred to herein as CPUs 880), accelerators, and/or other processor types. The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the machine(s) 800, sensor data indicating information about new or previously unexplored locations, and/or sensor data indicating changes to previously seen/stored locations (e.g., unexpected or changed road conditions, such as recently commenced road-work). The server(s) 878 may transmit, over the network(s) 890 and to the machine(s) 800, neural networks 892, updated neural networks 892, map information 894, etc., including information regarding traffic and road conditions. The updates to the map information 894 may include updates for the HD map 822, SD map, navigation map, etc., such as information regarding construction sites, potholes, detours, flooding, and/or other obstructions. In some examples, the neural networks 892, the updated neural networks 892, the map information 894, and/or the other information may have resulted from new training and/or experiences represented in data received from any number of machine(s) 800 in the environment, and/or based on training performed at a datacenter (e.g., using the server(s) 878 and/or other servers).

The server(s) 878 may be used to train machine learning models (e.g., neural networks) based on training data. The training data may be generated by the machine(s) 800, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 800 (e.g., transmitted to the machine(s) 800 over the network(s) 890, and/or the machine learning models may be used by the server(s) 878 to remotely monitor and/or control the machine(s) 800.

In some examples, the server(s) 878 may receive data from the machine(s) 800 and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the machine 800. For example, the deep-learning infrastructure may receive periodic updates from the machine 800, such as a sequence of images and/or objects that the machine 800 has located in that sequence of images (e.g., via computer vision and/or other machine learning object classification techniques). The deep-learning infrastructure may run its own neural network to identify the objects and compare them with the objects identified by the machine 800 and, if the results do not match and the infrastructure concludes that the AI in the machine 800 is malfunctioning, the server(s) 878 may transmit a signal to the machine 800 instructing a fail-safe computer of the machine 800 to assume control, notify the passengers, and complete a safety maneuver or operation—such as to slow down, hand control back to a driver, come to a stop, and/or pull over/shut down.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### COMPUTING ECOSYSTEM FOR GENERATING, TRAINING, AND DEPLOYING AI

FIG. 9 is a system diagram illustrating a three computer ecosystem 900, including a first computing system 902 for generating or creating artificial intelligence (AI)—such as AI training and validation data, a second computing system 904 for training artificial intelligence, and a third computing system 906 (which may include or correspond to the SoC(s) 804 of FIGS. 8A-8E) deploying the AI at the edge, in accordance with at least some embodiments of the present disclosure. For example, to develop and deploy embodied or physical AI, the three computer ecosystem 900 may be used, including three accelerated computer systems to handle physical AI training, simulation, and runtime (e.g., edge deployment). These systems may generate training data for and train multimodal foundation models (and/or other model types) using scalable, physically based simulations of the machine(s) 800 and their worlds. By doing so, simulation of machine(s) 800 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 800 can perform safely in controlled settings.

The computing system 904 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 800 to understand natural language and emulate movements by observing human actions. The computing system 904 may include a platform that incorporates software, infrastructure, and expertise in a modern, unified AI development and training solution. The computing system 904 may include individual computing devices 910 (e.g., NVIDIA's DGX B200, H200, etc.) and/or any number of computing devices 910 in a data center infrastructure 912 (e.g., NVIDIA's DGX SuperPOD).

For example, the individual computing devices 910 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 910 may include memory (e.g., 4 TB memory, and storage (e.g., OS storage of 2×1.9 TB NVMe M.2, and internal storage of 8×3.84 TB NVMe U.2). The computing devices 910 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 910 may further include, e.g., dual port quad small form-factor pluggable (QSFFP) data processing units (DPUs) (e.g., 2 dual-port QSFP 112 DPUs—such as NVIDIA's BlueField-3 DPUs), providing up to 400 Gb/s InfiniBand/Ethernet. The computing device(s) 910 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 910 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 910 may include a smart host channel adapter (HCA) (e.g., NVIDIA's ConnectX-7) to provide ultra-low latency, 400 Gb/s throughput for in-network computing acceleration engines.

The data center infrastructure 912 may include any number of the computing devices 910, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 910) to thousands, job scheduling and orchestration to ensure hassle-free execution of every developer's job, AI workflow management and machine learning operations (MLOps) to move more models from prototype to production, and enterprise software to speed developer success.

The computing system 902 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 902 allows developers to use simulation frameworks to simulate and validate robot models, and/or to generate massive amounts of physically-based synthetic data to bootstrap model training. The computing system 902 may support learning frameworks that power robot reinforcement learning and imitation learning, to accelerate robot policy training and refinement. For example, the computing system 902 may be used to generate any number of simulations 908—such as within NVIDIA's OMNIVERSE. The computing system 902 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 902 may host or support a native OpenUSD software platform enabling enterprises to connect 3D pipelines and develop advanced, real-time 3D applications for industrial digitalization. With powerful ray-tracing-accelerated AI and graphics capabilities, the computing system 902 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 902 may include individual computing devices 914 (e.g., NVIDIA's OVX L40S Server) and/or any number of computing devices 914 in a data center infrastructure 916 (e.g., NVIDIA's OVX Systems).

The computing device(s) 914 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen 4×16: 64 GB/s bidirectional interconnect interface, 18,176 CUDA cores, 142 ray tracing (RT) cores, and 568 tensor cores). The computing devices 914 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 914 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 914 may include a smart host channel adapter (HCA) (e.g., NVIDIA's ConnectX-7) to provide ultra-low latency, 400 Gb/s throughput for in-network computing acceleration engines. The computing device(s) 914 may include a host memory (e.g., 384 Gb DDR 5 ECC for 4 GPUs, or 768 Gb DDR 5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 912, the data center infrastructure 916 may allow for any number of computing device(s) 914 to be combined in cluster configuration according to a reference architecture.

The computing system 906 may be used to deploy trained AI models on a runtime computer—such as the SoC(s) 804 described herein. For example, these computing systems 906 may be designed for compact, on-board computing needs, including an ensemble of models for control policy, vision and language models, etc., deployed on a power-efficient on-board edge computing system 906. Details of components, features, and capabilities of the computing system 906 may be described in more detail herein with respect to FIGS. 8A-8E.

### EXAMPLE GENERATIVE MODELS

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10 is a block diagram of an example generative language model system 1000 suitable for use in implementing at least some embodiments of the present disclosure. In the example illustrated in FIG. 10, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a MMLM, a VLA model, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization (TN), for example, by converting all characters to lowercase, removing accents, and/or or handling special cases like contractions or abbreviations to ensure consistency (e.g., converting ¼ to one quarter). Similarly, the input processor 1005 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

In some embodiments, one or more transformer engines (TEs) may be implemented. The transformer engine may use micro-tensor scaling to optimize performance and accuracy—such as to enable 16-bit floating point (FP 16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### EXAMPLE COMPUTING DEVICE

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s), speaker(s), etc.), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

A: One or more processors comprising processing circuitry to: store, in a memory, one or more spatial features associated with one or more first images depicting an object; determine, using one or more neural networks and based at least on the one or more spatial features and second image data representative of one or more second images depicting the object, one or more attributes associated with the object; and cause a machine to perform one or more operations based at least on the one or more attributes associated with the object.

B: The one or more processors of paragraph A wherein the processing circuitry is further to: determine, based at least on at least one of the one or more spatial features or the second image data, a classification associated with the object, wherein the machine is further caused to perform the one or more operations based at least on the classification.

C: The one or more processors of either paragraph A or paragraph B, wherein the one or more processors in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

D: A method comprising: storing, in memory, a plurality of instances of spatial features respectively corresponding to a plurality of processing iterations of a convolutional neural network (CNN) feature extractor, an individual processing iteration of the plurality of processing iterations including the CNN feature extractor processing image data representative of one or more images depicting an object, the image data obtained using one or more image sensors at a time corresponding to the individual processing iteration; determining, using one or more CNN classifiers and based at least on the plurality of instances of spatial features, one or more states associated with one or more light signals of the object; and causing a machine to perform one or more planning, navigation, or control operations based at least on the one or more states of the one or more light signals.

E: The method of paragraph D, further comprising: determining, using the one or more CNN classifiers and based on at least one of the plurality of instances of spatial features, a classification associated with the object, wherein the causing the machine to perform the one or more operations is further based at least on the classification.

F: The method of either paragraph E or paragraph E, further comprising: generating combined spatial features by concatenating the plurality of instances of spatial features stored in the memory, wherein the determining the one or more states associated with the one or more light signals is based at least on the combined spatial features.

G: The method of any one of paragraphs D-F, further comprising: determining that a number of instances of the plurality of instances of spatial features stored in the memory satisfies a threshold number of instances, wherein the determining the one or more states associated with the one or more light signals is further based at least on the threshold number of instances being satisfied.

H: The method of any one of paragraphs D-G, further comprising removing one or more individual instances of spatial features from the memory based at least on the number of individual instances of spatial features reaching capacity.

I: The method of any one of paragraphs D-H, further comprising: storing, in the memory, one or more placeholder features that are associated with one or more predetermined values, wherein the determining the one or more states associated with the one or more light signals is further based at least on the one or more placeholder features.

J: The method of any one of paragraphs D-I, wherein the one or more states include or indicate at least one of: a cycling state; a left-turn state; a right-turn state; brake state; a reverse state; a hazard state; an emergency light state; a warning state; an on state; or an off state.

K: A system comprising: one or more processors to: generate, using one or more neural networks and based at least on image data representative of one or more images, one or more spatial features associated with the one or more images; store the one or more spatial features in a memory; determine, using the one or more neural networks and based at least on the one or more spatial features, one or more states associated with one or more light signals of an object; and cause a machine to perform one or more operations based at least on the one or more states of the one or more light signals.

L: The system of paragraph K, wherein the one or more processors are further to: determine, using the one or more neural networks and based at least on at least one of the one or more spatial features, a classification associated with the object, wherein the machine is further caused to perform the one or more operations based at least on the classification.

M: The system of either paragraphs K or paragraph L, wherein the one or more processors are further to generate combined spatial features by concatenating the one or more spatial features with one or more second spatial features stored in the memory, the one or more second spatial features associated with one or more second images, wherein the one or more states associated with the one or more light signals are determined based at least on the combined spatial features.

N: The system of any one of paragraphs K-M, wherein the one or more processors are further to: determine that a capacity associated with the memory satisfies a threshold, wherein the one or more states associated with the one or more light signals are further determined based at least on the capacity satisfying the threshold.

O: The system of any one of paragraphs K-N, wherein the one or more processors are further to remove, based at least the one or more spatial features being stored in the memory, one or more second spatial features from the memory, the one or more second spatial features associated with one or more second images.

P: The system of any one of paragraphs K-O, wherein the one or more processors are further to: store, in the memory, one or more placeholder features that are associated with one or more predefined values, wherein the one or more states associated with the one or more light signals are further determined based at least on the one or more placeholder features.

Q: The system of any one of paragraphs K-P, wherein the one or more processors are further to: generate one or more second spatial features by at least copying the one or more spatial features; and store the one or more second spatial features in the memory, wherein the one or more states associated with the one or more light signals are further determined based at least on the one or more second spatial features.

R: The system of any one of paragraphs K-Q, wherein the one or more states associated with the one or more light signals comprise at least one or more of: a cycling state; a left-turn state; a right-turn state; brake state; a reverse state; a hazard state; an emergency light state; a warning state; an on state; or an off state.

S: The system of any one of paragraphs K-R, wherein: the one or more spatial features associated with the one or more images are determined using one or more convolution neural network (CNN) extractors of the one or more neural networks; and the one or more states associated with the one or more light signals use one or more CNN extractors of the one or more neural networks.

T: The system of any one of paragraphs K-S, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
storing, in memory, a plurality of instances of spatial features respectively corresponding to a plurality of processing iterations of a convolutional neural network (CNN) feature extractor, an individual processing iteration of the plurality of processing iterations including the CNN feature extractor processing image data representative of one or more images depicting an object, the image data obtained using one or more image sensors at a time corresponding to the individual processing iteration;
determining, using one or more CNN classifiers and based at least on the plurality of instances of spatial features, one or more states associated with one or more light signals of the object; and
causing a machine to perform one or more planning, navigation, or control operations based at least on the one or more states of the one or more light signals.

2. The method of claim 1, further comprising:
determining, using the one or more CNN classifiers and based on at least one of the plurality of instances of spatial features, a classification associated with the object,
wherein the causing the machine to perform the one or more operations is further based at least on the classification.

3. The method of claim 1, further comprising:
generating combined spatial features by concatenating the plurality of instances of spatial features stored in the memory,
wherein the determining the one or more states associated with the one or more light signals is based at least on the combined spatial features.

4. The method of claim 1, further comprising:
determining that a number of instances of the plurality of instances of spatial features stored in the memory satisfies a threshold number of instances,
wherein the determining the one or more states associated with the one or more light signals is further based at least on the threshold number of instances being satisfied.

5. The method of claim 1, further comprising removing one or more individual instances of spatial features from the memory based at least on the number of individual instances of spatial features reaching capacity.

6. The method of claim 1, further comprising:
storing, in the memory, one or more placeholder features that are associated with one or more predetermined values,
wherein the determining the one or more states associated with the one or more light signals is further based at least on the one or more placeholder features.

7. The method of claim 1, wherein the one or more states include or indicate at least one of:
a cycling state;
a left-turn state;
a right-turn state;
brake state;
a reverse state;
a hazard state;
an emergency light state;
a warning state;
an on state; or
an off state.

8. A system comprising:
one or more processors to:
generate, using one or more neural networks and based at least on image data representative of one or more images, one or more spatial features associated with the one or more images;
store the one or more spatial features in a memory;
determine, using the one or more neural networks and based at least on the one or more spatial features, one or more states associated with one or more light signals of an object; and
cause a machine to perform one or more operations based at least on the one or more states of the one or more light signals.

9. The system of claim 8, wherein the one or more processors are further to:
determine, using the one or more neural networks and based at least on at least one of the one or more spatial features, a classification associated with the object,
wherein the machine is further caused to perform the one or more operations based at least on the classification.

10. The system of claim 8, wherein the one or more processors are further to:
generate combined spatial features by concatenating the one or more spatial features with one or more second spatial features stored in the memory, the one or more second spatial features associated with one or more second images,
wherein the one or more states associated with the one or more light signals are determined based at least on the combined spatial features.

11. The system of claim 8, wherein the one or more processors are further to:
determine that a capacity associated with the memory satisfies a threshold,
wherein the one or more states associated with the one or more light signals are further determined based at least on the capacity satisfying the threshold.

12. The system of claim 8, wherein the one or more processors are further to remove, based at least the one or more spatial features being stored in the memory, one or more second spatial features from the memory, the one or more second spatial features associated with one or more second images.

13. The system of claim 8, wherein the one or more processors are further to:
store, in the memory, one or more placeholder features that are associated with one or more predefined values,
wherein the one or more states associated with the one or more light signals are further determined based at least on the one or more placeholder features.

14. The system of claim 8, wherein the one or more processors are further to:
generate one or more second spatial features by at least copying the one or more spatial features; and
store the one or more second spatial features in the memory,
wherein the one or more states associated with the one or more light signals are further determined based at least on the one or more second spatial features.

15. The system of claim 8, wherein the one or more states associated with the one or more light signals comprise at least one or more of:
a cycling state;
a left-turn state;
a right-turn state;
brake state;
a reverse state;
a hazard state;
an emergency light state;
a warning state;
an on state; or
an off state.

16. The system of claim 8, wherein:
the one or more spatial features associated with the one or more images are determined using one or more convolution neural network (CNN) extractors of the one or more neural networks; and
the one or more states associated with the one or more light signals use one or more CNN extractors of the one or more neural networks.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising processing circuitry to:
store, in a memory, one or more spatial features associated with one or more first images depicting an object;
determine, using one or more neural networks and based at least on the one or more spatial features and second image data representative of one or more second images depicting the object, one or more attributes associated with the object; and
cause a machine to perform one or more operations based at least on the one or more attributes associated with the object.

19. The one or more processors of claim 18, wherein the processing circuitry is further to:
determine, based at least on at least one of the one or more spatial features or the second image data, a classification associated with the object,
wherein the machine is further caused to perform the one or more operations based at least on the classification.

20. The one or more processors of claim 18, wherein the one or more processors in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
